(19) United States
(12) Patent Application Publication
(10) Pub. No.: US 2015/0039479 A1
(43) Pub. Date: Feb. 5, 2015

(54) ELECTRONIC RECEIPT SYSTEM, MERCHANDISE SALES DATA PROCESSING APPARATUS, AND ELECTRONIC RECEIPT MANAGEMENT SERVER

(71) Applicant: Toshiba Tec Kabushiki Kaisha, Tokyo (JP)

(72) Inventors: Tsuyoshi GOTANDA, Oota Tokyo (JP); Taro ANDO, Izunokuni Shizuoka (JP); Keiichi HASEGAWA, Koto Tokyo (JP); Satoru ISHIHARA, Suita Osaka (JP)

(21) Appl. No.: 14/448,994

(22) Filed: Jul. 31, 2014

(30) Foreign Application Priority Data
Aug. 2, 2013 (JP) 2013-161340

(51) Int. Cl. G06Q 20/04

(52) U.S. Cl. CPC G06Q 20/045
USPC 705/30

(57) ABSTRACT

An electronic receipt management server includes a storage unit, a network interface configured to receive electronic receipt information related to a merchandise sale, membership information of a consumer associated with the merchandise sale, company information of a store associated with the merchandise sale, and a status indicating issuance of a paper receipt in association with the merchandise sale, and a processor. The processor is configured to function as an electronic receipt management unit that stores the electronic receipt information, the membership information, the company information and the status in the storage unit, an electronic receipt transmission unit that transmits the electronic receipt information, the membership information, and the company information to an information processing apparatus associated with the membership information, and a paper receipt issuance completion information transmission unit that transmits information indicating that issuance of the paper receipt has been completed according to the status.

### CROSS-REFERENCE TO RELATED APPLICATION

This application is based upon and claims the benefit of priority from Japanese Patent Application No. 2013-161340, filed Aug. 2, 2013, the entire contents of which are incorporated herein by reference.

### FIELD

Embodiments described herein relate generally to an electronic receipt system, a merchandise sales data processing apparatus, an electronic receipt management server, an information processing apparatus, and a program.

### BACKGROUND

In the related art, there is known a system for electronically delivering an electronic receipt to a portable terminal or the like of a consumer. The electronic receipt is delivered in place of a paper receipt which is handed over from a store to the customer who is a shopper as part of merchandise settlement.

The receipt of electronic data is useful to consumers since a household account book may be automatically kept. In addition, the introduction of the electronic receipt is also useful to stores since consumption of receipt paper may be reduced.

Further, there is a case where a coupon or the like related to purchased merchandise is electronically attached to an electronic receipt, and thus merchandise sales promotion or campaign advertisement is performed.

In circumstances in which such an electronic receipt is issued, a salesperson may operate a POS terminal and issue a paper receipt according to a consumer's wish in some cases.

However, in the electronic receipt system of the related art, when the electronic receipt is displayed on a portable terminal or the like, there is no indication whether the paper receipt is issued. For this reason, whether a paper receipt has been issued cannot be determined even if the electronic receipt displayed on the portable terminal or the like is viewed. Therefore, there is a possibility that accounting processing of using both the electronic receipt and the paper receipt may be performed.

### DESCRIPTION OF THE DRAWINGS

FIG. 1 is a diagram illustrating an entire configuration of an electronic receipt system according to an embodiment.

FIGS. 2A to 2D illustrate a series of displays for a consumer membership registration on a portable terminal.

FIG. 3 is a block diagram illustrating a configuration of the portable terminal.

FIG. 4 is a block diagram illustrating a configuration of a POS terminal.

FIG. 5 is a block diagram illustrating a configuration of an electronic receipt server.

FIG. 6 is a block diagram illustrating a configuration of an electronic receipt management server.

FIG. 7 is a functional block diagram according to an electronic receipt process in the POS terminal.

FIG. 8 is a flowchart illustrating an example flow of operations of the electronic receipt process.

FIG. 9 is a flowchart illustrating an example flow of operations of an information transmission process in the electronic receipt server.

FIG. 10 is a functional block diagram according to an electronic receipt management process and a merchandise information transmission process in the electronic receipt management server.

FIG. 11 is a flowchart illustrating an example flow of operations of the electronic receipt management process and the merchandise information transmission process.

FIG. 12 is a flowchart illustrating an example flow of operations in the POS terminal and the electronic receipt management server related to issuance of a receipt in parallel in a time series.

FIG. 13 is a functional block diagram according to an electronic receipt reception process and an electronic receipt viewing process in a portable terminal.

FIG. 14 is a flowchart illustrating an example flow of operations of the electronic receipt reception process and the electronic receipt viewing process.

FIGS. 15 to 21 illustrate examples of displays on the portable terminal.

FIG. 22 is a flowchart illustrating an example flow of operations of the electronic receipt reception process and the electronic receipt viewing process.

FIG. 23 illustrates an example of a display transition in the portable terminal.

FIG. 24 is a flowchart illustrating an example flow of operations of a statistical information generation process in the portable terminal.

FIGS. 25 and 26 illustrate examples of displays in the portable terminal.

FIGS. 27A to 27D illustrate a series of displays for a flow of receipt information transfer.

FIG. 28 illustrates an example of a display in a portable terminal which is a transfer destination.

### DETAILED DESCRIPTION

Embodiments provide an electronic receipt system, a merchandise sales data processing apparatus, an electronic receipt management server, an information processing apparatus, and a program capable of determining whether a receipt has been issued when an electronic receipt is viewed.

An electronic receipt management system according to an embodiment includes an electronic receipt management server and a merchandise sales processing apparatus.

The electronic receipt management server includes a storage unit, a network interface configured to receive electronic receipt information related to a merchandise sale, membership information of a consumer associated with the merchandise sale, company information of a store associated with the merchandise sale, and a status indicating issuance of a paper receipt in association with the merchandise sale, and a processor. The processor is configured to function as an electronic receipt management unit that stores the electronic receipt information, the membership information, the company information and the status in the storage unit, an electronic receipt transmission unit that transmits the electronic receipt information, the membership information, and the company information to an information processing apparatus associated with the membership information, and a paper receipt issuance completion information transmission unit that transmits information indicating that issuance of the paper receipt has been completed according to the status.

The merchandise sales processing apparatus includes a storage unit and a processor. The process is configured to function as an electronic receipt generation unit that generates electronic receipt information related to a merchandise sale, a receipt issuance unit that generates a paper receipt related to the merchandise sale, and a receipt issuance determination unit that determines whether a paper receipt was issued in association with the merchandise sale. The merchandise sales processing apparatus further includes a network interface configured to transmit, to an electronic receipt management server, the electronic receipt information, membership information of a consumer associated with the merchandise sale, company information of a store associated with the merchandise sale, and status indicating issuance of a paper receipt in association with the merchandise sale.

An exemplary embodiment will be described with reference to the drawings.

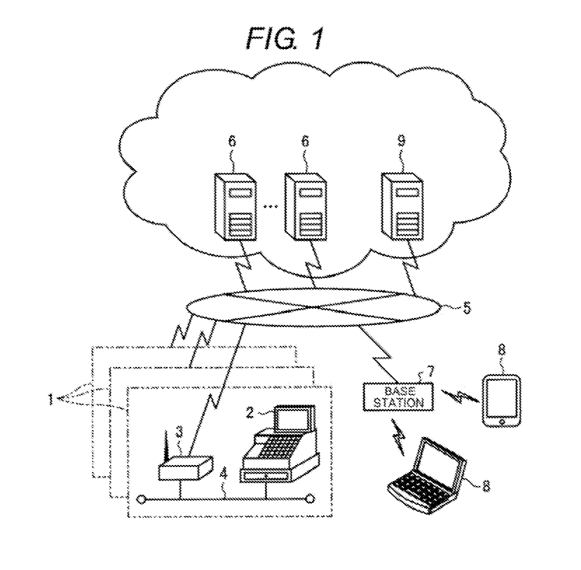

FIG. 1 is a diagram illustrating an entire configuration of an electronic receipt system according to the embodiment. As illustrated in FIG. 1, a store 1 is provided with a point of sales (POS) terminal 2, which is a merchandise sales data processing apparatus performing a merchandise sales data process, and a router 3. Only one terminal 2 is illustrated in FIG. 1 but a plurality of terminals may be used. The POS terminal 2 and the router 3 are connected to each other via an in-store local area network (LAN) 4. The router 3 connects the in-store LAN 4 to a network 5 such as the Internet or a virtual private network (VPN). In addition, although not particularly illustrated, the store 1 may be provided with a store server which controls the POS terminal 2.

The network 5 is connected to electronic receipt servers 6. A plurality of the electronic receipt servers 6 are provided on a company-wide basis for a company which is a seller of merchandise or services and that operates stores or chain stores (hereinafter, referred to as a store). Examples of the store include a convenience store, a supermarket, a foodstuff store, a drugstore, an apparel store, a home electric appliance shop, a department store, a household goods store, and an eating house. The electronic receipt server 6 functions as a company receipt management server which stores and manages electronic receipt information for each company operating store, as indicated by a company code. In addition, the electronic receipt server 6 may also be a headquarter server for a POS system which includes functions such as sales management, sales analysis, and inventory management of each company operating stores.

Further, a portable terminal 8 is connected to the network 5 via a base station 7 which performs wireless communication according to a standard such as Wireless Fidelity (Wi-Fi). The portable terminal 8 is an information processing apparatus such as a smart phone, a mobile phone, a personal, digital assistant (PDA), or a tablet computer in which a web browser is mounted. Furthermore, an information processing apparatus such as a personal computer, for example, a notebook PC may be employed instead of the portable terminal 8.

In addition, the network 5 is also connected to an electronic receipt management server 9 which functions as a customer electronic receipt management server which collectively stores and manages electronic receipt information of various companies operating stores. A consumer who registers as a member in advance to receive an electronic receipt service may obtain electronic receipt information from the electronic receipt management server 9 via the network 5 by using the portable terminal 8. Furthermore, the electronic receipt management server 9 may perform the functions of the electronic receipt server 6, and thus electronic receipt information may be managed by a single server. Moreover, a function of collectively managing electronic receipt information for each company and its company operating stores may be provided as a service (application) in a form of, for example, software as a service (SaaS) which is a type of cloud computing.

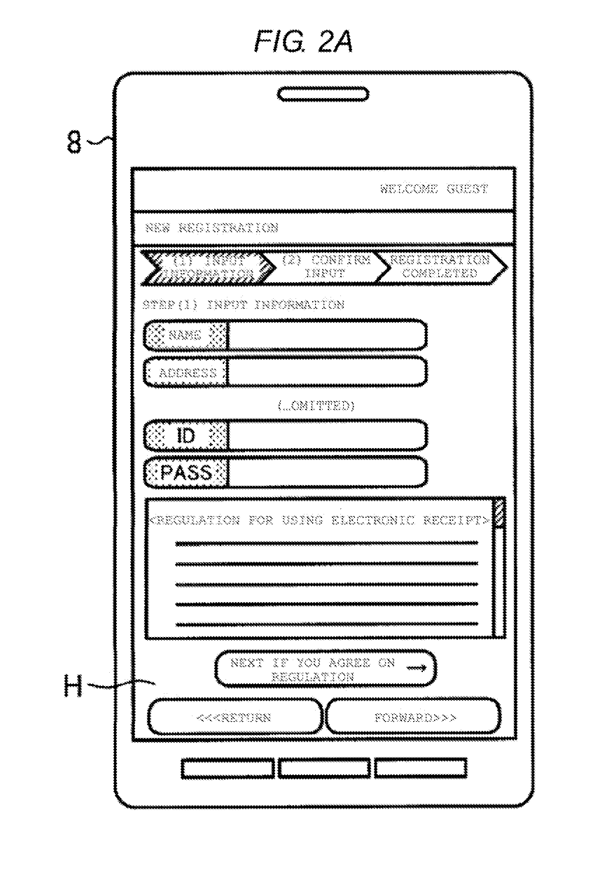

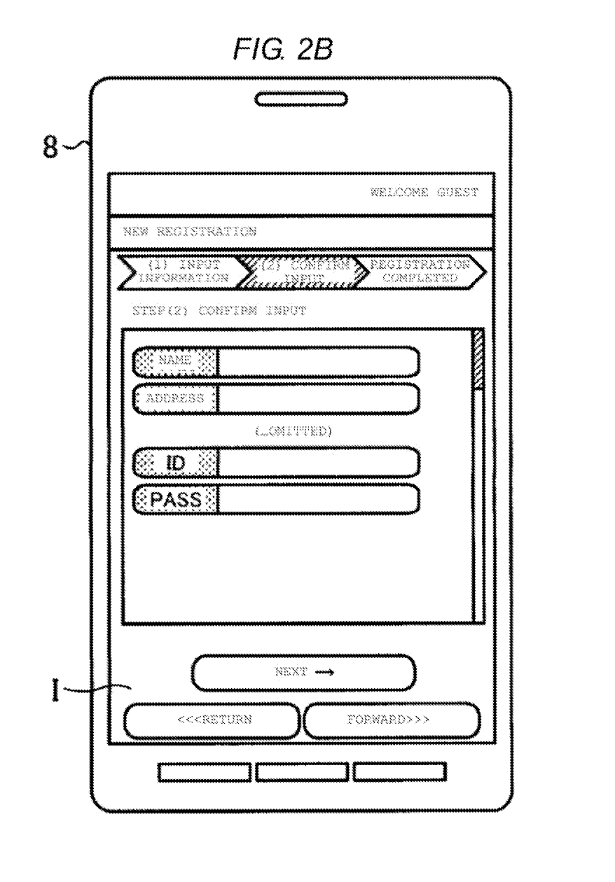

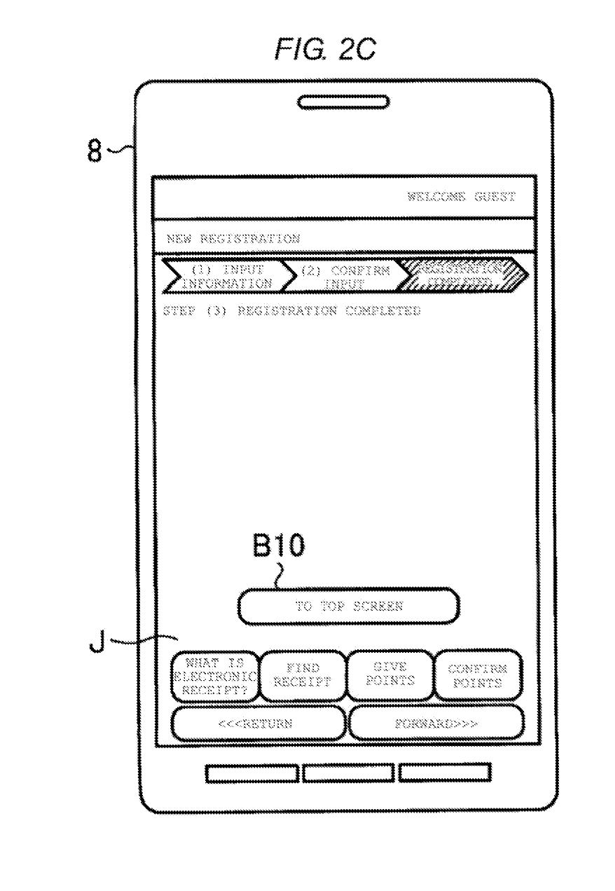

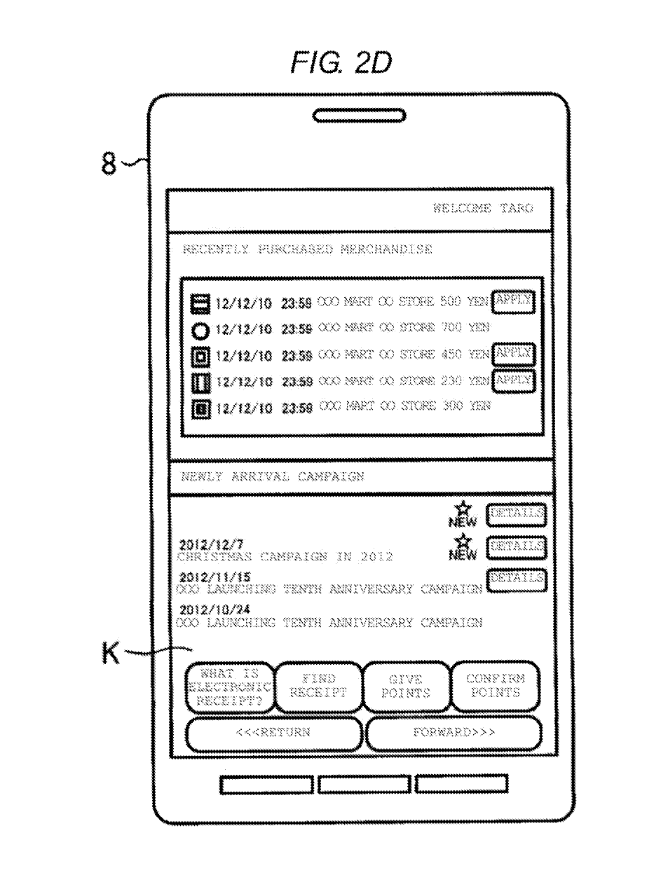

In addition, membership registration of a consumer for receiving an electronic receipt service is performed as follows, for example. FIGS. 2A to 2D illustrate a series of displays for a consumer membership registration. The consumer transmits a blank email from the portable terminal. 8 to a membership management server (not illustrated) via the network 5. The membership management server transmits a uniform resource locator (URL) indicating a page for membership registration to the email address of the received blank email. The consumer accesses the URL indicating the page for member registration from the portable terminal 8 so as to display an input screen H (refer to FIG. 2A), and inputs items necessary for the membership registration. After the inputting of necessary items by the consumer is completed, an input confirmation screen I is displayed on the portable terminal 8 (refer to FIG. 2B). The consumer confirms the input, and then membership registration is performed on a membership master. Next, the membership management server delivers a membership registration completion mail including a membership code and a password to the portable terminal 8. Accordingly, the membership registration is finished. In addition, FIG. 2C illustrates a registration completion screen J displayed on the portable terminal 8 after the registration is completed. A “top screen display” button B10 is provided on the registration completion screen J. When the customer operates the “top screen display” button B10, the portable terminal 8 displays a top screen K illustrated in FIG. 2D.

In the electronic receipt system with this configuration, a merchandise sales data process is performed by the POS terminal 2 of the store 1. Electronic receipt information indicating generated content of settlement is transmitted to the electronic receipt management server 9 via the electronic receipt server 6 through the network 5. The electronic receipt information is transmitted to the portable terminal 8 of a member from the electronic receipt management server 9. The member may display the electronic receipt information on a display unit of the portable terminal 8 so as to confirm the content thereof. In addition, the electronic receipt management server 9 publishes the electronic receipt information to a web site. The portable terminal 8 in which a web browser is mounted designates a uniform resource locator (URL) so as to download the electronic receipt information published on the web site to the portable terminal 8 and view the electronic receipt information with the web browser. Further, application software for viewing the electronic receipt information may be installed in the portable terminal 8 so that the electronic receipt information may be viewed.

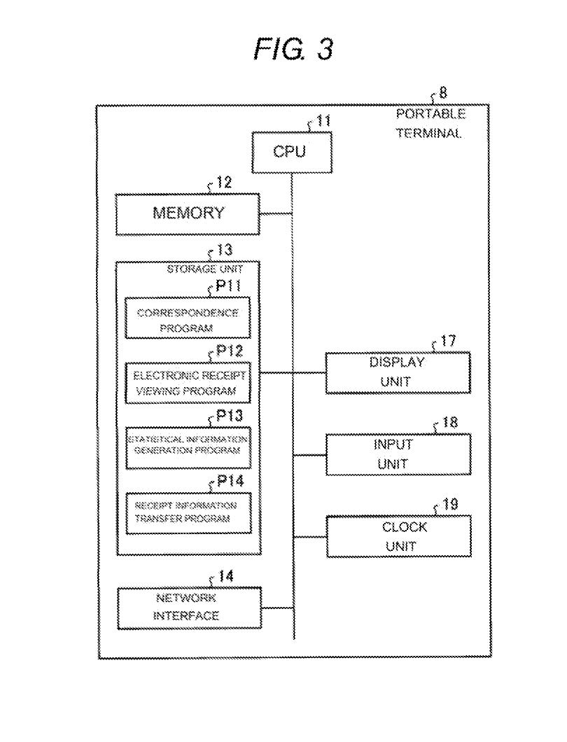

The portable terminal 8 stores the membership code and the password acquired by the consumer in the manner as described above in a storage unit 13 (refer to FIG. 3). Different methods of outputting the membership code stored in this way include: display using a barcode, display using a two-dimensional code, transmission through information communication using near field communication (NFC) which is near field wireless communication, and the like.

In addition, association between a membership code acquired in order for a consumer to receive an electronic receipt service and an existing company membership card such as a point service of a chain store operated by a company may be realized by the FOS terminal 2 of each retail store or the portable terminal 8 of each person.

Here, description will be made of an operation example for associating a membership code acquired by a consumer with an existing company membership card as described above.

1. Operation Example in POS Terminal 2 of Store

(1) First, a checker operating the POS terminal 2 checks whether an electronic receipt service is performed, and whether there is a point card, during merchandise registration (settlement). If the electronic receipt service is performed, the consumer presents the portable terminal 8 and the point card.

(2) The checker reads the membership code stored in the portable terminal 8 and the company membership code of the point card, respectively. Here, reading of the membership code stored in the portable terminal 8 depends on an I/O provided in the POS terminal 2, and employs the above-described barcode, two-dimensional code, NFC, or the like.

(3) The POS terminal 2 transmits the membership code and the company membership code of the point card read in (2) to the electronic receipt management server 9.

(4) The electronic receipt management server 9 receives the information transmitted in (3), and stores the information therein if electronic receipt information indicating content of settlement generated by the POS terminal 2 of the store 1 performing a merchandise sales data process, the membership code, and the company membership code of the point card are transmitted together for the first time.

Thereafter, the consumer may utilize the electronic receipt system or the point service by presenting the portable terminal 8 or the point card.

2. Operation Example in Portable Terminal 8

(1) First, the consumer logs in to a point card registration menu by accessing a specific URL from the consumer's own portable terminal 8 or by using an application installed in the portable terminal 8. The consumer inputs and selects the company which has issued a point card, which is a registration target. Successively, the consumer inputs a company membership code of the point card which is the registration target, confirms the number, and presses a registration button so that registration content is transmitted to the electronic receipt management server 9. In addition, the company membership code may be manually input, and may be input through camera capturing, magnetic reading, or the like.

(2) The electronic receipt management server 9 receives the registration content in the portable terminal 8 in (I), and collates the content with customer information of each company so as to return an acknowledgment display screen to the portable terminal 8 of the consumer.

(3) The consumer confirms the acknowledgment display screen returned from the electronic receipt management server 9 and presses an agreement button so that association between the membership code of the electronic receipt and the existing company membership card is completed.

As mentioned above, a service in the electronic receipt system or the point service is managed by using the unique membership code of the electronic receipt, and thus the service in the electronic receipt system may be received by presenting the point card at a store where the consumer has the old point card, or by presenting the portable terminal. 8 at a store where the consumer does not have the point card. As a result, the membership code of the electronic receipt may function as a hub for association with each company membership card of a company.

Hereinafter, a configuration of the electronic receipt system according to the present embodiment will be described.

First, a configuration of the portable terminal 8, which is an information processing apparatus, will be described with reference to a block diagram of FIG. 3. As illustrated in FIG. 3, the portable terminal 8 includes a central processing unit (CPU) 11 forming a main controller, a memory 12 which temporarily stores data, a storage unit 13 which allows a program or data to be read or written in response to a command from the CPU 11 and stores the program or the data, a network interface 14 which is connected to various public networks including the network 5, a display unit 17 which may display information, an input unit 18 which allows the portable terminal 8 to be operated, a clock unit 19 which counts time, and the like. The input unit 18 may be a touch panel formed on the display unit 17 or keys provided on a casing.

A web browser for viewing various information pieces (content items) published on a web, an electronic receipt correspondence program P11 for receiving electronic receipt information generated after settlement due to a merchandise sales data process from the electronic receipt management server 9, and an electronic receipt viewing program P22 for viewing the received electronic receipt information are each installed in the storage unit 13 in advance.

A statistical information generation program P13—for generating statistical information from the statistics of electronic receipt information received from the electronic receipt server 6 of each company described later based on a company code or a business type and business category code—is also installed in the storage unit 13 in advance.

A receipt information transfer program P14 for transferring divided electronic receipt information to other people is also installed in the storage unit 13 in advance.

The electronic receipt correspondence program P11, the electronic receipt viewing program P12, the statistical information generation program P13, and the receipt information transfer program P14 which are executed by the portable terminal 8 may be recorded on a computer readable recording medium such as a flash memory, a CD-ROM, a flexible disc (FD), a CD-R, a digital versatile disk (DVD) or the like, in an installable or executable file format.

In addition, the electronic receipt correspondence program P11, the electronic receipt viewing program P12, the statistical information generation program P13, and the receipt information transfer program P14 which are executed by the portable terminal 8 may be stored on a computer connected to a network such as the Internet and may be downloaded via the network so as to be provided. Further, the electronic receipt correspondence program P11, the electronic receipt viewing program P12, the statistical information generation program P13, and the receipt information transferprogram P14 which are executed by the portable terminal 8 may be provided or distributed via a network such as the Internet.

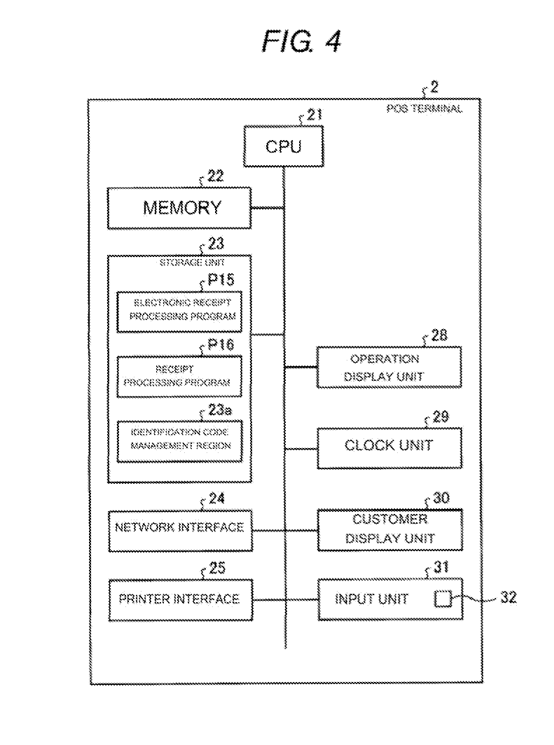

Next, a main part configuration of the POS terminal 2, which is a merchandise sales data processing apparatus, will be described with reference to a block diagram of FIG. 4. As illustrated in FIG. 4, the POS terminal 2 includes a central processing unit (CPU) 21 forming a controller main body, a memory 22 which temporarily stores data, a storage unit 23 which allows a program or data to be read or written in response to a command from the CPU 21 and stores the program or the data, a network interface 24 which is connected to the in-store LAN 4, a printer interface 25 which is connected to a printer, an operator display unit 28 which displays various information pieces to an operator, a clock unit 29 which counts time, a customer display unit 30 which displays various information pieces to customers, an input unit 31 which includes a receipt key 32 when a receipt is issued according to a customer's demand and allows the POS terminal 2 to be operated, and the like.

An identification code management region 23a is defined in the storage unit 23 as a region for storing in advance not only a POS number of the POS terminal 2, but also a company code (an identification code of a company operating stores), a business type and business category code, a store code indicating the store 1 in which the POS terminal 2 is installed, and the like. Here, the business type and business category code is a classification code for differentiating business types and business categories from each other, such as a convenience store, a supermarket, a department store, a pharmacy, a restaurant, and an eating house. In addition, such business types and business categories may be changed depending on user's taste. Further, the company code (an identification code of a company operating stores) and the business type and business category code may be recorded in the electronic receipt server 6.

Further, the storage unit also stores software for executing various POS business including a merchandise sales data process and also an electronic receipt processing program P15 for processing electronic receipt information which is electronically processed instead of a receipt which is printed and issued when a merchandise sales data process is performed.

Furthermore, a receipt processing program P16 for issuing a receipt, inquiring about whether a receipt is issued, and determining whether a receipt is issued, is installed in the storage unit 23 in advance.

The electronic receipt processing program P15 and the receipt processing program P16 executed by the POS terminal 2 are recorded on a computer readable recording medium such as a flash memory, a CD-ROM, a flexible disc (FD), a CD-R, a digital versatile disk (DVD) or the like, in an install-able or executable file format.

In addition, the electronic receipt processing program P15 and the receipt processing program P16 executed by the POS terminal 2 may be stored on a computer connected to a network such as the Internet and may be downloaded via the network. Further, the electronic receipt processing program P15 and the receipt processing program P16 executed by the POS terminal 2 may be provided or distributed via a network such as the Internet.

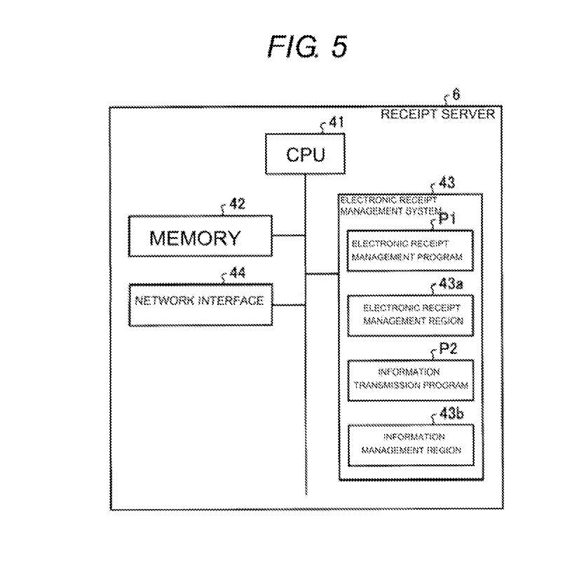

Next, a main part configuration of the electronic receipt server 6, which functions as a company electronic receipt management server, will be described with reference to a block diagram of FIG. 5. The electronic receipt server 6 includes a central processing unit (CPU) 41 forming a controller main body, a memory 42 which temporarily stores data, a storage unit 43 which allows a program or data to be read or written in response to a command from the CPU 41 and stores the program or the data, and a network interface 44 which is connected to the network 5.

An electronic receipt management region 43a is defined in the storage unit 43 as a region for storing electronic receipt information for each company operating stores. The electronic receipt information includes a company code (i.e., an identification code of a company operating stores), a business type and business category code, a store code, a membership code of a consumer, a POS number of the POS terminal 2, a receipt number, merchandise sales data, and the like.

In addition, an electronic receipt management program P1 for managing electronic receipt information received from the POS terminal 2 of each store 1 in the electronic receipt management region 43a is installed in the storage unit 43 in advance.

Further, an information transmission program P2 for transmitting the electronic receipt information managed in the electronic receipt management region 43a to the electronic receipt management server 9 is installed in the storage unit 43 in advance.

Further, an information management region 43b for storing various additional information pieces correlated with desired merchandise, members, companies, and stores is also provided in the storage unit 43. Here, the additional information is access information such as an URL for a link to a home page associated with a campaign of a company, a URL for a link to a home page associated with a CM of a company, or a URL for a link to a coupon of a company.

The electronic receipt management program P1 and the information transmission program P2 executed by the electronic receipt server 6 are recorded on a computer readable recording medium such as a flash memory, a CD-ROM, a flexible disc (FD), a CD-R, or a digital versatile disk (DVD) or the like, in an installable or executable file format.

In addition, the electronic receipt management program P1 and the information transmission program P2 executed by the electronic receipt server 6 may be stored on a computer connected to a network such as the Internet and may be downloaded via the network so as to be provided. Further, the electronic receipt management program P1 and the information transmission program P2 executed by the electronic receipt server 6 may be provided or distributed via a network such as the Internet.

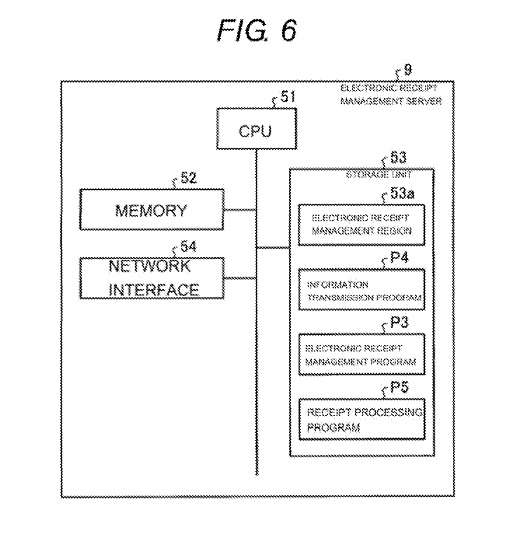

Next, a configuration of the electronic receipt management server 9, which functions as a customer receipt management server, will be described with reference to a block diagram of FIG. 6. The electronic receipt management server 9 includes a central processing unit (CPU) 51 forming a controller main body, a memory 52 which temporarily stores data, a storage unit 53 which allows a program or data to be read or written in response to a command from the CPU 51 and stores the program or the data, a network interface 54 which is connected to the network 5, and the like.

An electronic receipt management region 53a is defined in the storage unit 53 as a region for collectively storing electronic receipt information pieces of various companies operating stores. More specifically, the electronic receipt management region 53a manages electronic receipt information and additional information of various companies operating stores for each member. The electronic receipt information includes a membership code, a company code (an identification code of a company operating stores), a store code, a POS number of the POS terminal 2, a receipt number, merchandise sales data, additional information, and the like.

In addition, an electronic receipt management program P3 for managing additional information and electronic receipt information received from the electronic receipt server 6 of each company in the electronic receipt management region 53a is installed in the storage unit 53 in advance.

An information transmission program P4 for transmitting electronic receipt information, a status information indicating that a receipt has been issued, and additional information of desired merchandise to the portable terminal 8 is also installed in the storage unit 53 in advance.

Furthermore, a receipt processing program P5, which examines whether a receipt has been issued when an inquiry about issuance of the receipt is made, and transmits an examination result to the POS terminal 2, is installed in the storage unit 53 in advance.

The electronic receipt management program P3, the information transmission program P4, and the receipt processing program P5 executed by the electronic receipt management server 9 are recorded on a computer readable recording medium such as flash memory, a CD-ROM, a flexible disc (FD), a CD-R, a digital versatile disk (DVD) or the like in an installable or executable file format.

In addition, the electronic receipt management program P3, the information transmission program P4, and the receipt processing program P5 executed by the electronic receipt management server 9 may be stored on a computer connected to a network such as the Internet and may be downloaded via the network so as to be provided. Further, the electronic receipt management program P3, the information transmission program P4, and the receipt processing program P5 executed by the electronic receipt management server 9 may be provided or distributed via a network such as the Internet.

Next, an operation of each part building the system of the present embodiment will be described.

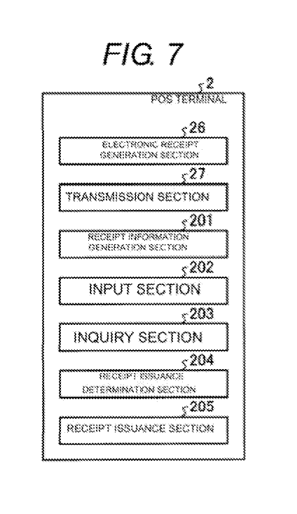

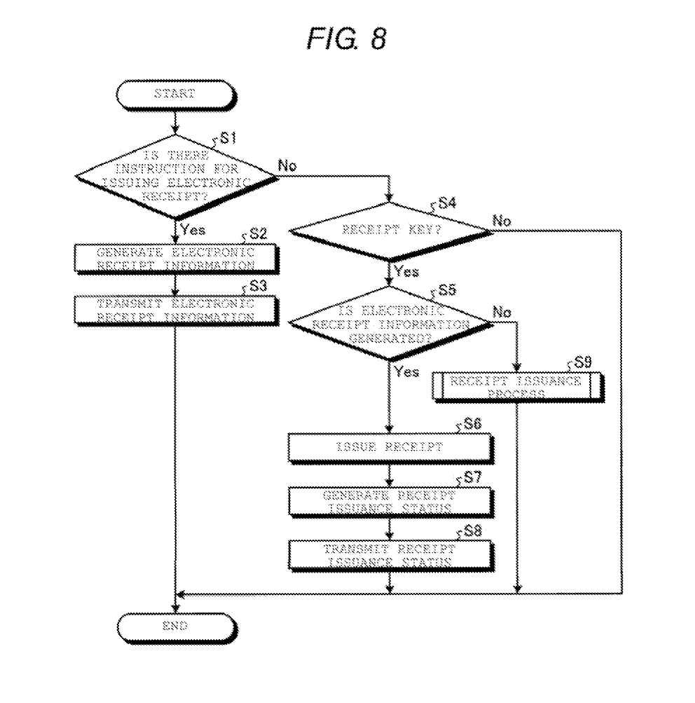

First, with reference to a functional block diagram illustrated in FIG. 7 and a flowchart illustrated in FIG. 8, description is made of an electronic receipt process performed by the CPU 21 of the POS terminal 2 being operated according to the electronic receipt processing program P15.

As illustrated in FIG. 7, the electronic receipt processing program P15 and the receipt processing program P16 executed in the POS terminal 2 have a modular configuration which includes: an electronic receipt generation section 26 which functions as electronic receipt generation unit, a transmission section 27 which functions as transmission unit, a receipt information generation section 201 which functions as receipt information generation unit, an input section 202 which functions as input unit, an inquiry section 203 which functions as inquiry unit, a receipt issuance determination section 204 which functions as receipt issuance determination unit, and a receipt issuance section 205 which functions as receipt issuance unit. When the CPU 21 reads and executes the electronic receipt processing program P15 and the receipt processing program P16 from the storage unit 23, the respective sections are loaded on the memory 22. Thus the electronic receipt generation section 26, the transmission section 27, the receipt information generation section 201, the input section 202, the inquiry section 203 which functions as inquiry unit, the receipt issuance determination section 204 which functions as receipt issuance determination unit, and the receipt issuance section 205 which functions as receipt issuance unit, are generated on the memory 22 and implemented by the CPU 21.

The electronic receipt generation section 26 generates electronic receipt information which includes the company code and is electronically processed, instead of a paper receipt being printed and issued during a merchandise sales data process, in correlation with a membership code of a consumer.

In addition, in cases where the receipt key 32 is operated and a paper receipt is issued, the electronic receipt generation section 26 generates a status (for example, a flag) indicating that the paper receipt has been issued and associates the status with electronic receipt information.

The transmission section 27 transmits the electronic receipt information generated by the electronic receipt generation section 26 to the electronic receipt server 6 which performs management on a company basis in accordance with a company code. If a status indicating that a paper receipt has been issued is generated, the electronic receipt information is transmitted in association with the status.

If issuance of a paper receipt is instructed through an operation of the receipt key 32, the receipt information generation section 201 generates a status indicating a paper receipt related to merchandise sales data has been issued.

The input section 202 reads, for example, information for specifying electronic receipt information which is displayed as a barcode on the display unit 17 of the portable terminal 8 with the input unit 18, and inputs the information thereto.

If the information for specifying electronic receipt information is input, and issuance of a paper receipt is instructed through an operation of the receipt key 32, the inquiry section 203 inquires the electronic receipt management server 9 about whether a paper receipt has been issued based on the input information for specifying electronic receipt information.

The receipt issuance determination section 204 determines whether a paper receipt may be issued based on a response from the electronic receipt management server 9 to the inquiry about whether a paper receipt has been issued, made by the inquiry section 203.

If the receipt issuance determination section 204 determines that a paper receipt may be issued, the receipt issuance section 205 instructs issuance of the paper receipt.

As illustrated in FIG. 8, if a settlement operation key or the like for starting settlement processing of merchandise transaction is input, the CPU 21 (the electronic receipt generation section 26) of the POS terminal 2 determines whether a membership code is input, whether electronic receipt information has been issued, and whether there is an electronic receipt issuance instruction corresponding to settlement processing in accordance with the settlement operation (step S1).

In order for a member to indicate an electronic receipt issuance instruction, for example, the following methods are considered.

1. A salesperson operates an “electronic receipt issuance” button provided in the input unit 31 (for example, a keyboard) of the POS terminal 2.

2. A consumer who is a member displays a barcode including a code serving as a trigger on the display unit 17 of the portable terminal 8, and a salesperson reads the barcode with the input unit 31 (for example, a barcode scanner) of the POS terminal 2.

3. A consumer who is a member operates the “electronic receipt issuance” button which is displayed so as to be pressed on the customer display unit 30.

4. A consumer who is a member displays a barcode including a code serving as a trigger on the display unit 17 of the portable terminal 8, and the consumer who is a member in person reads the barcode with the input unit 31 (for example, a barcode scanner (a scanner different from a scanner used to register merchandise is preferably used)) of the POS terminal 2.

5. A consumer who is a member presents a company membership card for receiving a point service, reads a company membership code of the company membership card with the input unit 31 (for example, a barcode scanner, a magnetic card reader, NFC, or the like) of the POS terminal 2, and determines that there is an electronic receipt issuance instruction if a membership code of electronic receipt is associated with the read company membership code.

6. If a consumer requests issuance of a paper receipt, a salesperson operates the receipt key 32.

If the CPU 21 (the electronic receipt generation section 26) of the POS terminal 2 determines that there is the electronic receipt issuance instruction (Yes in step S1), the CPU 21 transmits merchandise transaction data to a headquarter server. The CPU 21 then extracts a company code (an identification code of a company operating stores), a business type and business category code, a store code, a membership code of a consumer, a POS number of the POS terminal 2, a receipt number, merchandise sales data, and the like from the identification code management region 23a provided in the storage unit 23, based on information on merchandise and information on settlement registered during the settlement due to a merchandise sales data process. The electronic receipt generation section 26 processes the extracted information so as to generate electronic receipt information (step 32).

The CPU 21 (the transmission section 27) of the POS terminal 2 is connected to the in-store LAN 4 and the network 5 via the network interface 24. The CPU 21 transmits the generated electronic receipt information to the electronic receipt server 6 (step S3) and finishes the process.

In addition, the CPU 21 of the POS terminal 2 implements the following countermeasures so as to prevent data loss if an offline state occurs when merchandise transaction data is transmitted to the headquarter server.

1. Retry transmission is automatically performed.

2. If the offline state is not remedied with the above 1., the merchandise transaction data is stored until an online state is recovered, and is sent to the headquarter server after the online state is recovered. In this case, the CPU 21 of the POS terminal 2 displays a message such as “Merchandise transaction data will be transmitted later” on the operator display unit 28.

If the CPU 21 determines that there is no electronic receipt issuance instruction in step S1 (No in step S1), the CPU 21 determines whether the receipt key 32 is operated (step S4). If the CPU 21 determines that the receipt key 32 is not operated (No in step S4), the CPU 21 finishes the process in this state.

If the CPU 21 determines that the receipt key 32 is operated (Yes in step S4), the CPU 21 determines whether the electronic receipt information is generated in step S2 (step S5). If the CPU 21 determines that the electronic receipt information is generated (Yes in step S5), the CPU 21 generates printing data of a paper receipt based on the generated electronic receipt information, and instructs printing by transmitting the printing data from the printer interface 25 to a printer (not illustrated) (step S6). The printer prints and issues a paper receipt based on the printing data.

Next, the CPU 21 generates a status indicating that the paper receipt has been issued (step S7). The status may employ any information such as a flag as long as the information indicates that a paper receipt has been issued. In addition, the CPU 21 transmits the generated status to the electronic receipt server 6 in association with the electronic receipt information (step SB).

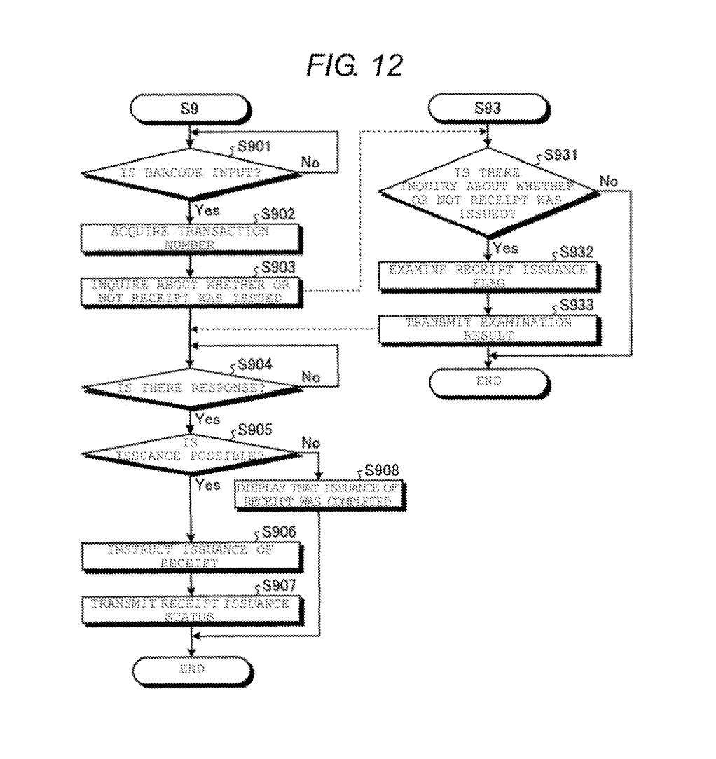

On the other hand, in step S55, if the CPU 21 determines that electronic receipt information is not generated in step S2 (No in step S5), the CPU 21 performs receipt issuance processing (step S9). The receipt issuance processing in step S9 will be described in detail with reference to FIG. 12.

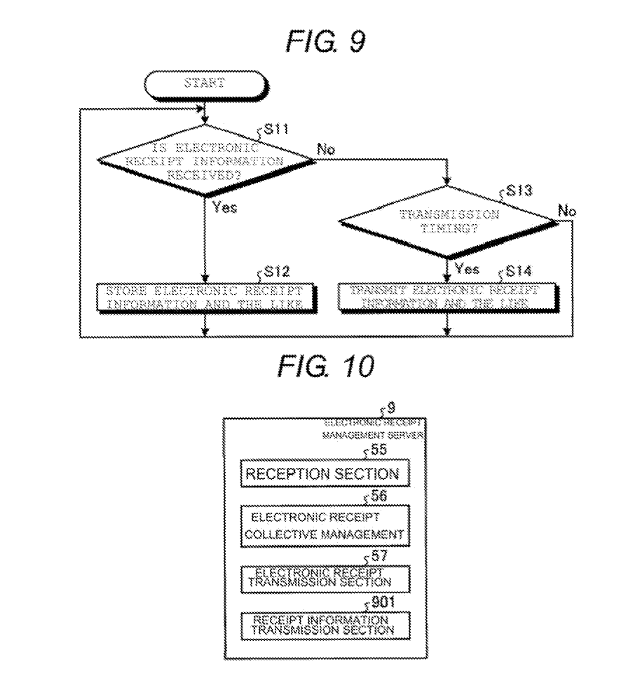

Next, with reference to a flowchart illustrated in FIG. 9, description will be made of flows of an electronic receipt management process performed by the CPU 41 of the electronic receipt server 6 being operated according to the electronic receipt management program P1 and an information transmission process performed by the CPU 41 being operated according to the information transmission program P2.

If the electronic receipt information transmitted from the POS terminal 2 and the information indicating that a paper receipt has been issued are received via the network interface 44, the CPU 41 of the electronic receipt server 6 (Yes in step S11), the CPU 41 stores the information in the electronic receipt management region 43a of the storage unit 43 as electronic receipt information for each company (step S12). In other words, the CPU 41 of the electronic receipt server 6 functions as an electronic receipt management unit that manages the electronic receipt information and the status indicating that a paper receipt has been issued in the storage unit 43 on a company basis in accordance with a company code.

In addition, the CPU 41 of the electronic receipt server 6 stores the received electronic receipt information, additional information, and status indicating that a receipt has been issued. Then, at a preset transmission timing (No in step S11, and Yes in step S13), the CPU 41 associates additional information managed in the information management region 43b and electronic receipt information managed in the electronic receipt management region 43a with the status indicating that a paper receipt has been issued, so as to transmit the information to the electronic receipt management server 9 (step S14), and returns to step S11.

If the CPU 41 determines that the transmission timing does not occur (No in step S13), the CPU 41 finishes the process in this state.

Although the CPU 21 (the electronic receipt generation section 26) of the POS terminal 2 generates electronic receipt information which is transmitted to the electronic receipt server 6, is not limited thereto. For example, the CPU 21 of the POS terminal 2 may transmit a store code, a membership code of a consumer, a POS number of the POS terminal 2, a receipt number, merchandise sales data, and the like to the electronic receipt server 6 based on information on merchandise and information on settlement during the settlement due to a merchandise sales data process. Thereafter, the CPU 41 of the electronic receipt server 6 may generate electronic receipt information by adding a company code, a business type and business category code, and the like thereto.

In addition, after the electronic receipt information is generated, a status accompanied by issuance of a paper receipt may be generated retroactively on the time of generation of the electronic receipt information. For example, a paper receipt may be issued based on the generation date and time of the generated electronic receipt information or a transaction number, a status may be generated at that time so as to be associated with the electronic receipt information. In this case, the status is transmitted again in association with the new electronic receipt information.

Further, in relation to electronic receipt information associated with a status since a paper receipt has been issued, the paper receipt is not reissued even if a receipt issuance operation is performed again by using the receipt key 32.

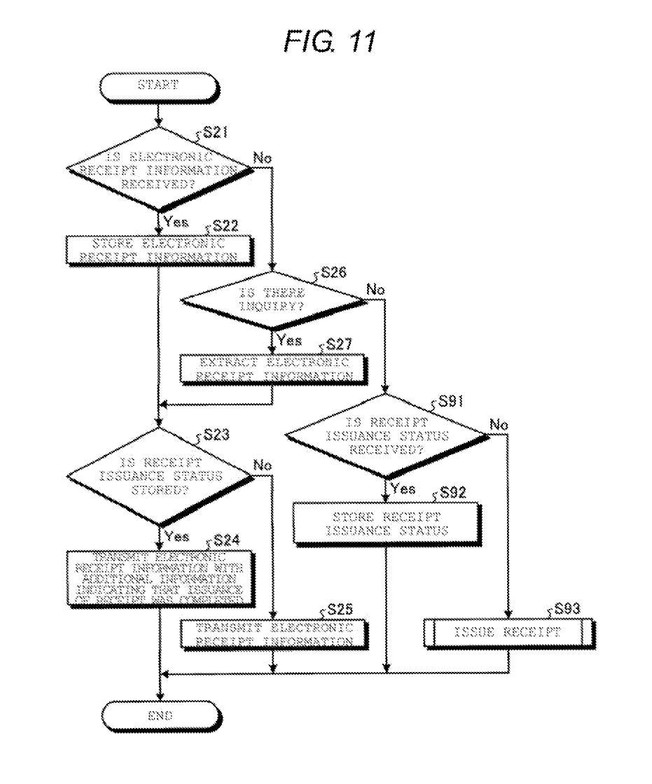

Next, with reference to a functional block diagram illustrated in FIG. 10 and a flowchart illustrated in FIG. 11, description will be made of an electronic receipt management process performed by the CPU 51 of the electronic receipt management server 9 being operated according to the electronic receipt management program P3 and a merchandise information transmission process performed by the CPU 51 being operated according to the information transmission program P4.

As illustrated in FIG. 10, the electronic receipt management program P3 and the information transmission program P4 executed in the electronic receipt management server 9 have a modular configuration which includes: a reception section 55 which functions as reception unit, an electronic receipt collective management section 56 which functions as electronic receipt collective management unit, and an electronic receipt transmission section 57 which functions as electronic receipt transmission unit. As practical hardware, when the CPU 51 reads and executes the electronic receipt management program P3 and the information transmission program P4 from the storage unit 53, the respective sections are loaded on the memory 52. Thus the reception section 55, the electronic receipt collective management section 56, the electronic receipt transmission section 57, and a receipt information transmission section 901 are generated on the memory 52 and implemented by the CPU 51.

The reception section 55 receives electronic receipt information on a company basis, which includes a company code indicating a company operating stores and is electronically processed instead of a paper receipt which is printed and issued during a merchandise sales data process. If a paper receipt has been issued, a status is received in association with the electronic receipt information.

The electronic receipt collective management section 56 stores the electronic receipt information on a company basis and the status received by the reception section 55 in the electronic receipt management region 53a of the storage unit 53, and collectively manages the information.

The electronic receipt transmission section 57 acquires the electronic receipt information, which is correlated with a corresponding membership code and includes one or more company code and information indicating that a paper receipt has been issued from the electronic receipt management region 53a, and transmits information to the portable terminal 8 correlated with the membership code of a predetermined consumer.

The receipt information transmission section 901 transmits propriety information based on a status managed in the electronic receipt collective management section 56 to the FOS terminal 2 in response to an inquiry about whether a paper receipt has been issued from the POS terminal 2.

As illustrated in FIG. 11, the CPU 51 (the reception section 55) of the electronic receipt management server 9 determines whether electronic receipt information or additional information transmitted from the electronic receipt server 6 of each company or a status indicating that a paper receipt has been issued is received via the network interface 54 (step S21).

If the CPU 51 (the electronic receipt collective management section 56) of the electronic receipt management server 9 determines that the electronic receipt information, the additional information, or the status indicating that a paper receipt has been issued is received (Yes in step S21), the CPU 51 collectively stores the electronic receipt information and the additional information of various companies in the electronic receipt management region 53a of the storage unit 53 (step S22). If the status indicating that a paper receipt has been issued is received, the status is stored in the electronic receipt management region 53a in association with the electronic receipt information along with the electronic receipt information and the additional information (step S22).

Next, the CPU 51 determines whether a status indicating that the POS terminal 2 instructs issuance of a paper receipt is stored in the electronic receipt management region 53a (step S23). If the CPU 51 determines that the status is stored (Yes in step S23), the CPU 51 (the electronic receipt transmission section 57) adds information indicating that issuance of a paper receipt has been completed, such as text information, for example, “issuance of a paper receipt has been completed” to the electronic receipt information, and transmits the electronic receipt information to the portable terminal 8 (step S24).

In addition, if the CPU 51 determines in step S23 that the status is not stored (No in step S23), the CPU 51 (the electronic receipt transmission section 57) transmits the electronic receipt information to the portable terminal 8 without adding information indicating that issuance of a paper receipt has been completed thereto (step S25).

If the CPU 51 determines in step S21 that the electronic receipt information and the additional information are not received (No in step S21), the CPU 51 determines whether an inquiry about electronic receipt information is made by the portable terminal 8 (step S26). If the CPU 51 determines that an inquiry about electronic receipt information is made by the portable terminal 8 (Yes in step S26), the CPU 51 extracts additional information and electronic receipt information managed in the electronic receipt management region 53a in accordance with content of the inquiry about electronic receipt information (step S27). In addition, the CPU 51 performs the above steps S23 to S25.

If the CPU 51 determines in step S26 that an inquiry about electronic receipt information is not made by the portable terminal 8 (No in step S26), the CPU 51 determines whether a status indicating that a paper receipt has been issued due to a process in step S907 described later is received from the POS terminal 2 (step S91). If the CPU 51 determines that the status indicating that a paper receipt has been issued is received (Yes in step S91), the CPU 51 stores the status in the electronic receipt management region 53a in association with corresponding electronic receipt information (step S92).

In addition, if the CPU 51 determines in step S91 that a status indicating that a paper receipt has been issued is not received (No in step S91), the CPU 51 performs a receipt issuance process (step S93). The receipt issuance process in step S93 will be described in detail with reference to FIG. 12.

Next, description will be made of the process in step S9 performed by the CPU 21 and the process in step S93 performed by the CPU 51 with reference to FIG. 12. FIG. 12 is a flowchart illustrating comparison between control processes in issuance of a paper receipt of the POS terminal 2 and the electronic receipt management server 9 related to the issuance of a paper receipt when the receipt issuance process is performed by reading a barcode 61 displayed on the display unit 17 of the portable terminal 8.

The CPU 21 of the POS terminal 2 determines whether barcode information is input by reading the barcode 61 with a code reader or the like (step S901). The CPU 21 waits for the barcode information to be input (No in step S901). If the CPU 21 determines that the barcode information is input (Yes in step S901), the CPU 21 acquires a transaction number of transaction which causes a corresponding electronic receipt to be generated, from the input barcode information (step S902). In addition, the CPU 21 inquires the electronic receipt management server 9 about whether a paper receipt for the transaction is issued based on the acquired transaction number (step S903).

The CPU 51 of the electronic receipt management server 9 determines whether there is an inquiry about whether a paper receipt is issued (step S931). If the inquiry in step S903 is received, the CPU 51 determines that there is an inquiry about whether a paper receipt is issued (Yes in step S931). Then, the CPU 51 searches the electronic receipt management region 53a by using the transaction number included in the inquiry, and examines whether a paper receipt has been issued depending on whether a status related to issuance of a receipt for the transaction is stored (step S932). If a paper receipt has been issued, a status indicating that the receipt has been issued is stored in the electronic receipt management region 53a in correspondence with the transaction. The CPU 51 examines whether there is the status. In addition, the CPU 51 transmits an examination result to the POS terminal 2 (step S933). On the other hand, if the CPU 51 determines that there is no inquiry about whether a paper receipt is issued (No in step S931), the process is finished in this state.

The CPU 21 of the POS terminal 2 determines whether a response to the inquiry is received from the electronic receipt management server 9 (step S904). The CPU 21 waits for the response to be received (No in step S904), and if the CPU 21 determines that the response is received (Yes in step S904), the CPU 21 determines whether a paper receipt may be issued based on the content of the response from the electronic receipt management server 9 (step S905).

If the CPU 21 determines that a paper receipt cannot be issued (No in step S905), the CPU 21 displays a reason why a paper receipt cannot be issued—for example, a comment such as “issuance of a receipt has been completed”-on the operator display unit 28.

On the other hand, if the CPU 21 determines that a paper receipt may be issued (Yes in step S905), the CPU 21 acquires receipt information based on the input transaction number, and instructs issuance of a paper receipt by outputting printing data of the paper receipt to the printer interface 25 (step S906). In addition, the CPU 21 generates a status indicating that the paper receipt has been issued and transmits the status to the electronic receipt management server 9 (step S907).

The CPU 51 of the electronic receipt management server 9 which receives the status determines Yes in step S91, and performs step S92.

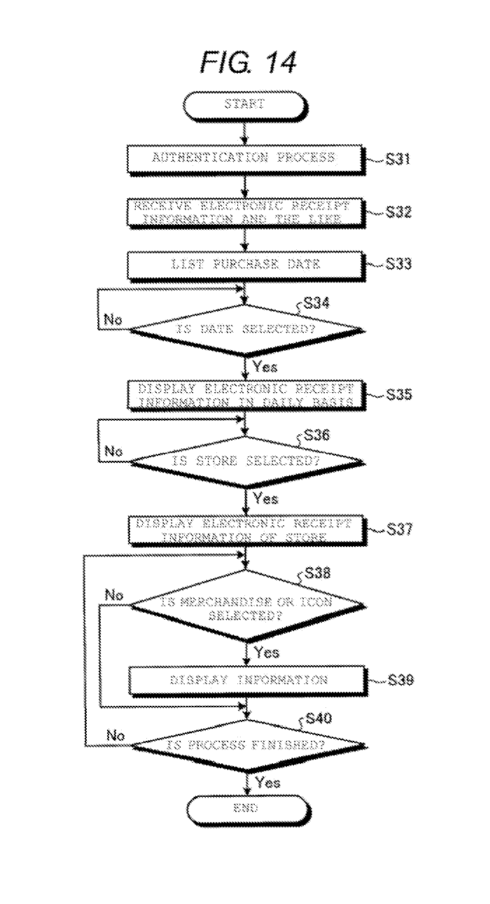

Next, with reference to the functional block diagram illustrated in FIG. 1.3 and the flowchart illustrated in FIG. 14, description will be made of flows of an electronic receipt reception process performed by the CPU 11 of the portable terminal 8 being operated according to the electronic receipt correspondence program P11 and an electronic receipt viewing process performed by the CPU 11 being operated according to the electronic receipt viewing program P12.

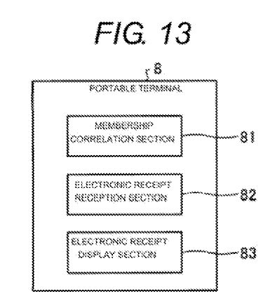

As illustrated in FIG. 13, the electronic receipt correspondence program P11 and the electronic receipt viewing program P12 executed in the portable terminal 8 have a modular configuration to include: a membership correlation section 81 which functions as membership correlation unit, an electronic receipt reception section 82 which functions as electronic receipt reception unit, and an electronic receipt display section 83 which functions as electronic receipt display unit. As practical hardware, when the CPU II reads and executes the electronic receipt correspondence program P11 and the electronic receipt viewing program P12 from the storage unit 13, the respective sections are loaded on the memory 12. Thus the membership correlation section 81, the electronic receipt reception section 82, and the electronic receipt display section 83 are generated on the memory 12 and implemented in the CPU 11.

The membership correlation section 81 performs correlation with a membership code of a predetermined consumer.

The electronic receipt reception section 82 receives electronic receipt information which is correlated with a membership code and includes one or more company code, from the electronic receipt management server 9 which collectively manages the electronic receipt information. If a paper receipt has been issued, information indicating that issuance of the paper receipt has been completed is received.

The electronic receipt display section 83 arranges and displays the electronic receipt information received by the electronic receipt reception section 82 on a company code basis on the display unit 17. If information indicating that issuance of a paper receipt has been completed is received, the information indicating that issuance of a paper receipt has been completed is displayed on the display unit 17 so as to be added to the electronic receipt information.

As illustrated in FIG. 14, first, the CPU 11 (the membership correlation section 81) of the portable terminal 8 accesses the electronic receipt management server 9, and performs an authentication process by inputting a membership code and a password (step S31). Accordingly, the portable terminal 8 is correlated with the membership code of a predetermined consumer.

After the authentication process is performed, the CPU 11 (the electronic receipt reception section 82) of the portable terminal 8 receives additional information and electronic receipt information which are managed in the electronic receipt management region 53a in correspondence with the input membership code (step 332). If issuance of a paper receipt has been completed, information indicating that the issuance of a paper receipt has been completed is received. In addition, the additional information, the electronic receipt information, and the information indicating that issuance of a paper receipt has been completed may be received in an email.

Next, the CPU 11 (the electronic receipt display section 83) of the portable terminal 8 lists the purchase date included in the electronic receipt information on the display unit 17 (step S33). As mentioned above, the purchase date is listed on the display unit 17, and thus the portable terminal 8 prompts a user who is a consumer to select information.

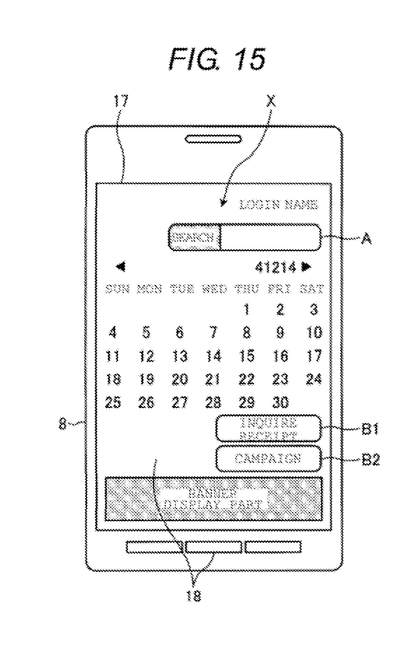

FIG. 15 is a front view illustrating a display example X on the display unit 17 of the portable terminal 8. As illustrated in FIG. 15, in the display example X, the dates on which a user who owns the portable terminal 8 that accesses the electronic receipt management server 9 does shopping at stores of various companies are listed with changed colors in a calendar form. In addition, the CPU 11 (the electronic receipt display section 83) of the portable terminal 8 performs the display so that a desired date may be selected with a cursor which tracks an input of the input unit 18 among the dates listed with changed colors.

In addition, as illustrated in FIG. 15, in the display example X, a search window A for designating a language serving as a search key or a keyword is provided. The CPU 11 of the portable terminal 8 may identify electronic receipt information based on language or a keyword designated in the search window A.

Further, in the display example X, as illustrated in FIG. 15, a “receipt inquiry” button B1 for fixing a desired date selected with the cursor is provided. The CPU 11 of the portable terminal 8 may determine that a date is selected when the user just taps the desired date, and may determine that a date is selected when the user taps the desired date and then operates the “receipt inquiry” button B1.

In addition, in the display example X, as illustrated in FIG. 15, a “campaign” button B2 for transition to an application type campaign page is provided.

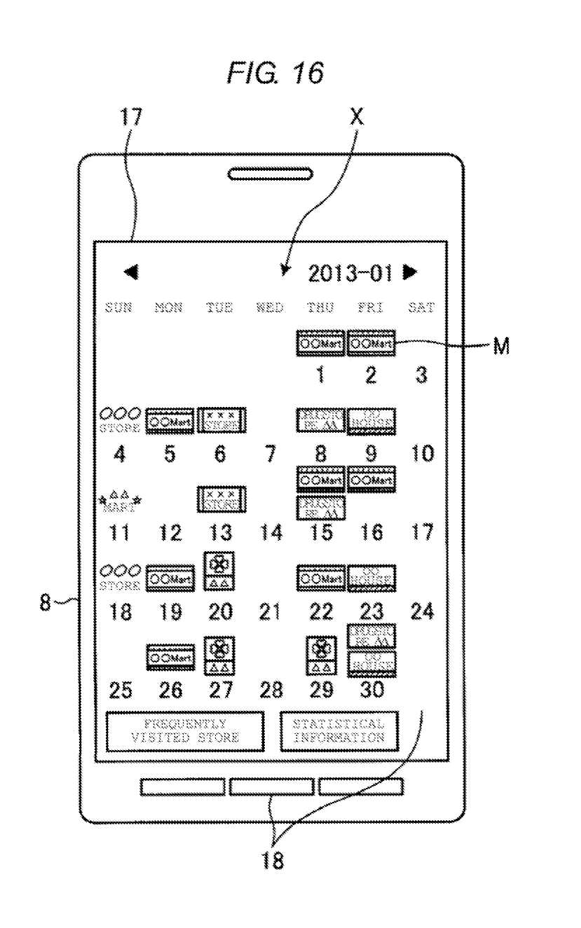

FIG. 16 illustrates a modification example of the display example X. In the display example X illustrated in FIG. 16, marks M of stores of various companies are appended to the dates on which a user who owns the portable terminal 8 that accesses the electronic receipt management server 9 does shopping at the stores of the companies. Thus the stores at which the user does shopping may be identified. In other words, according to the display example X illustrated in FIG. 16, information on at a store of which company shopping is frequently done may be easily understood. In addition, in order to display the mark M of a store, a table which correlates a mark with a company code included in electronic receipt information in advance is prepared.

If the CPU 11 determines that that the user selects a desired date by tapping the date (Yes in step S34), the CPU 11 (the electronic receipt display section 83) of the portable terminal 8 displays electronic receipt information corresponding to the selected date on the display unit 17 (step S35).

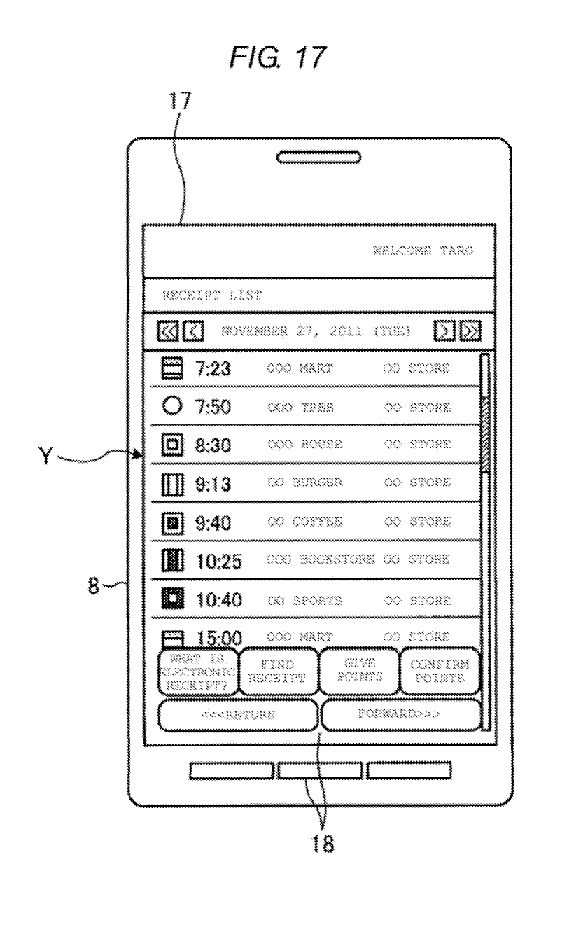

FIG. 17 is a front view illustrating a display example Y in the portable terminal. As illustrated in FIG. 17, in the display example Y, stores of various companies at which the user who owns the portable terminal 8 that accesses the electronic receipt management server 9 does shopping are listed. More specifically, in the display example Y, the electronic receipt information is displayed in an order in which the electronic receipt information is received. A company mark, a transaction time, a company name, and a store name are displayed. In addition, the CPU 11 (the electronic receipt display section 83) of the portable terminal 8 performs the display so that a desired store in daily basis is selected with a cursor which tracks an input of the input unit 18 among the listed stores in daily basis.

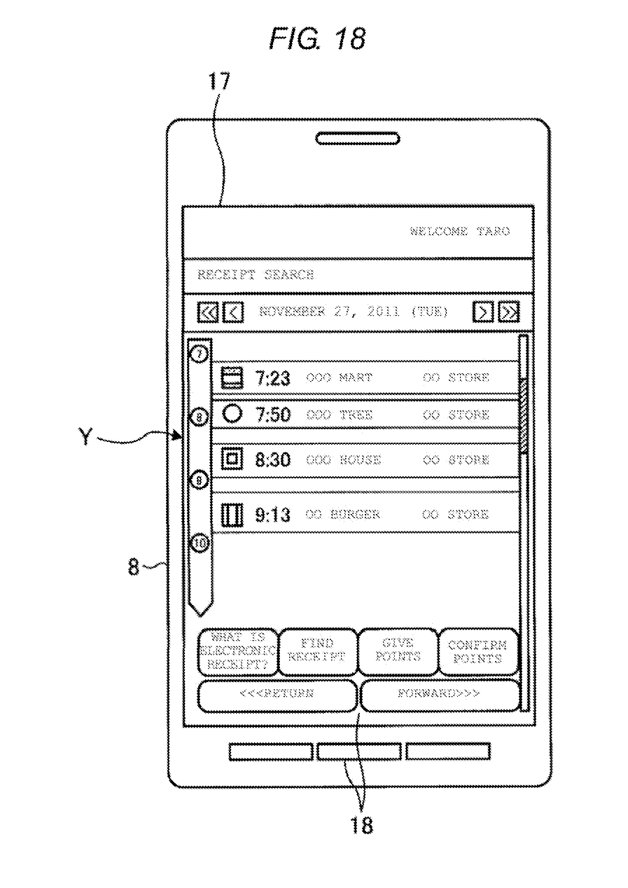

In addition, FIG. 18 is a modification example of the display example Y. In the display example Y of FIG. 18, a “time bar” in which the time is displayed at predetermined time intervals is displayed. FIG. 18 illustrates an example of an hour interval. Since electronic receipt information is displayed at predetermined time intervals as mentioned above, circumstances in a blank time when electronic receipt information is not displayed are perceived, and thus a time when there is no electronic receipt information, that is, shopping has been not done at a store is easily identified.

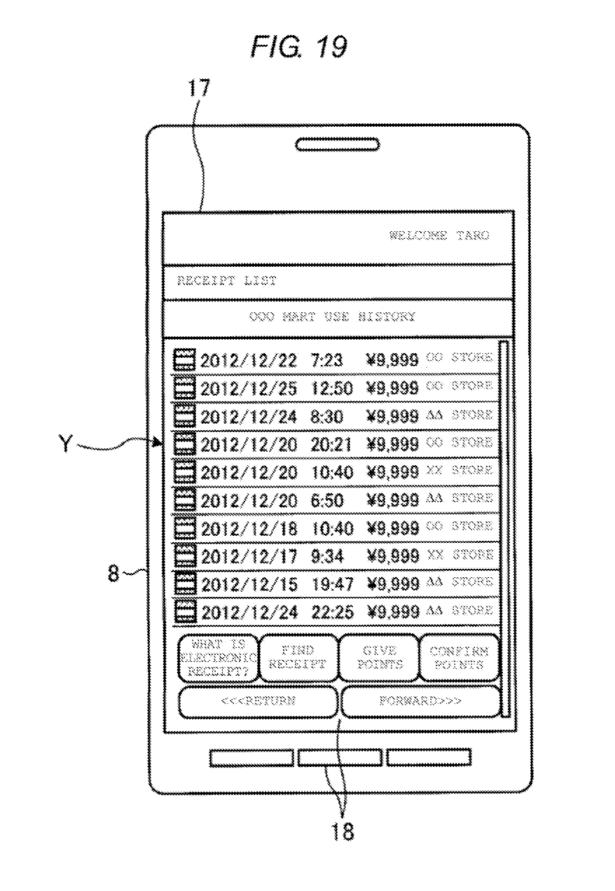

FIG. 19 also illustrates a modification example of the display example Y. In the display example Y of FIG. 19, a company mark of the display example Y is touched, and then only use history at stores of a specific company is sorted in a time series and is listed. As mentioned above, only stores of a company which is highly frequently used are listed, and thus use circumstances are easily identified.

If the CPU 11 determines that the user selects a desired store in daily basis (Yes in step S36), the CPU 11 (the electronic receipt display section 83) of the portable terminal 8 displays electronic receipt information corresponding to the selected store in daily basis on the display unit 17 (step S37).

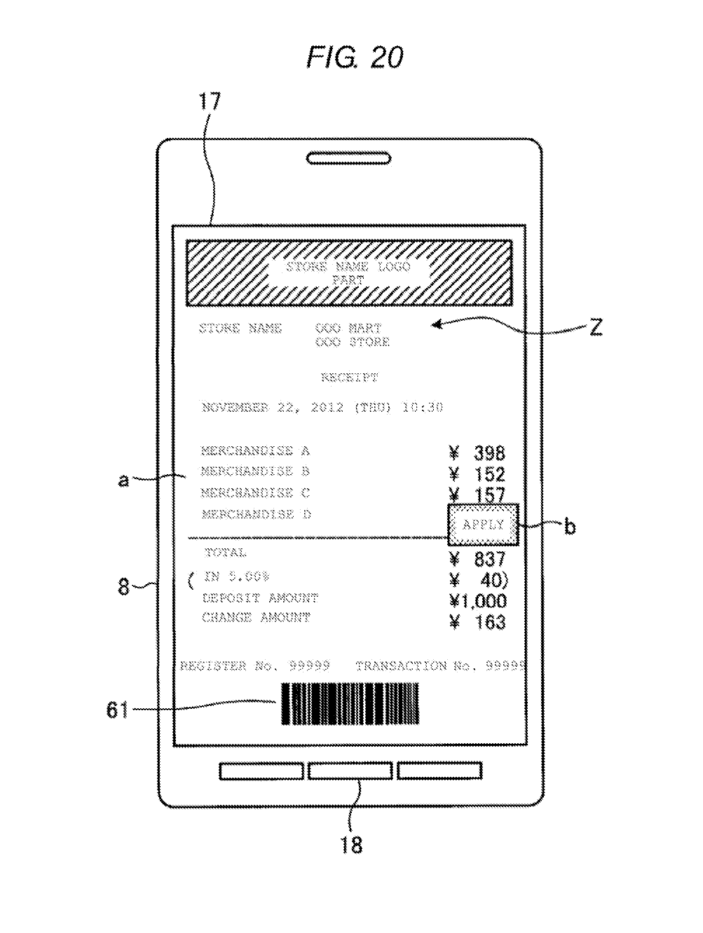

FIG. 20 is a front view illustrating a display example Z on the display unit 17 of the portable terminal 8. As illustrated in FIG. 20, the display example Z displays electronic receipt information of a desired store on the desired date on which the user who owns the portable terminal 8 that accesses the electronic receipt management server 9 does shopping. In the display example Z, the same layout as that of a paper receipt is displayed by analyzing the electronic receipt information. Merchandise a or an icon b (a button-shaped icon indicating “application” in FIG. 20) indicating various additional information pieces correlated with the merchandise may be focused among the information pieces with a cursor which tracks an input of the input unit 18.

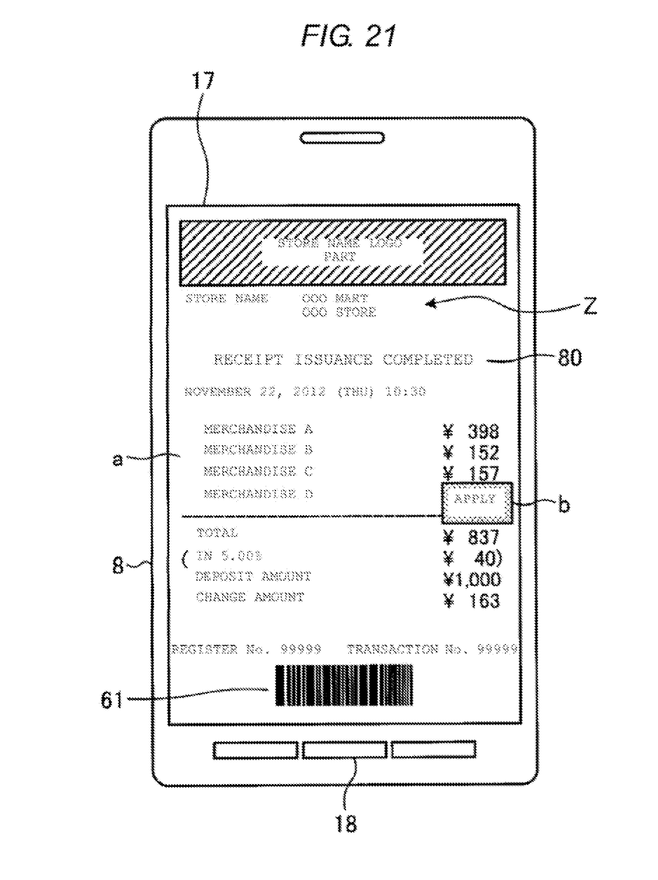

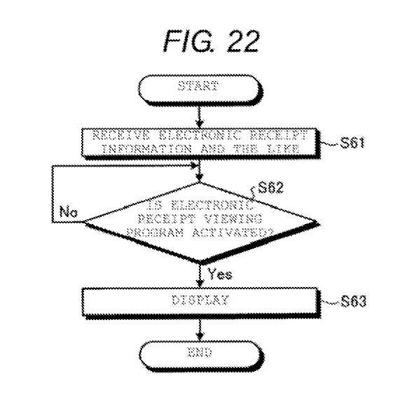

In addition, if information indicating a paper receipt has been issued is received, display is performed as illustrated in FIG. 21. Text information 80 such as “issuance of a receipt has been completed” is displayed in addition to the electronic receipt information. The text information 80 such as “issuance of a receipt has been completed” is displayed in a highlighted manner so that the fact that issuance of a paper receipt has been completed may be clearly understood from the POS terminal 2 in transaction related to the electronic receipt information. For example, the text information is displayed in a font larger than a typical character. For example, the text information is displayed by a conspicuous color such as red. For example, the text information is displayed by a thick letter.

In addition, a screen display image is not necessarily required to be a paper receipt image. However, the electronic receipt information is used instead of paper receipt information, and is thus electronic merchandise purchase evidence information which verifies purchase of merchandise. In the display example Z, the following information is displayed in order to use the electronic receipt information which is presented to a store as merchandise purchase evidence information if the merchandise is returned:
Store name;
Purchase date and time;
Details of purchased merchandise;
Total sales amount;
Deposit amount;
Change amount;
Register number;
Transaction number;
Information indicating that “issuance of receipt has been completed” (if paper receipt has been issued);
Barcode 61 obtained as codes of register number, transaction number; and
Transaction date and time.

As described above, the barcode 61 obtained as codes of the register number, the transaction number, and the transaction date and time is displayed along with the register number and the transaction number indicating transaction related to corresponding electronic receipt information on the display unit 17 of the portable terminal 8. The displayed barcode 61 is optically read with a code reader or the like.

Next, an outline of a merchandise returning process will be described. As described above, a consumer may refer to electronic receipt information in the past with the consumer's own membership code as a key.

In the merchandise returning process in the present embodiment, in the same manner as in a case of a merchandise returning process using a paper receipt, merchandise is returned by displaying and confirming electronic receipt information on the display unit 17 of the portable terminal 8 or by confirming receipt information which is printed in advance when the merchandise is returned.

1. A consumer displays target electronic receipt information on the display unit 17 of the portable terminal 8 along with returned merchandise and presents the electronic receipt information to a store.

2. A salesperson makes a journal search based on the sales date and time, a register number, and a transaction number from the presented electronic receipt information, and confirms transaction content.

3. The salesperson operates the POS terminal 2 so as to perform the merchandise returning process.

4. The CPU 21 of the POS terminal 2 updates electronic receipt information managed in the electronic receipt management region 43a of the electronic receipt server 6 since the original electronic receipt information may be required to be invalidated after the merchandise returning process is performed.

5. The CPU 21 of the POS terminal 2 issues electronic receipt information when the merchandise is returned.

6. In addition, the electronic receipt server 6 updates electronic receipt information managed in the electronic receipt management region 53a of the electronic receipt management server 9 which functions as a customer receipt management server so as to invalidate the original electronic receipt information. Then, the electronic receipt server 6 updates the electronic receipt management region 53a of the electronic receipt management server 9 with the electronic receipt information when the merchandise is returned, and preserves the electronic receipt management region 53a.

Here, if the user selects proper merchandise or an icon correlated with the merchandise (Yes in step S38), the CPU 11 (the electronic receipt display section 83) of the portable terminal 8 is connected to the network 5 via the network interface 14, and acquires various information pieces based on access information associated with the selected merchandise or icon from the network 5 so as to display the information on the display unit 17 (step S39).

For example, if a home page associated with merchandise and having access information to the merchandise is set as a merchandise information link, when desired merchandise is selected, the home page associated with the merchandise is displayed on the display unit 17.

In addition, if a home page associated with an application campaign is set as access information for the button-shaped icon b indicating “application”, when the “application” button is selected, the application campaign page associated with the “application” button is displayed on the display unit 17.

In addition, if a home page associated with CM is set in a banner c which is a kind of icon as access information, when the banner c is selected, the CM associated with the banner c is displayed on the display unit 17.

The CPU 11 of the portable terminal 8 finishes the process if finishing of the electronic receipt viewing process is indicated from the input unit 18 (Yes in step S40).

If finishing of the electronic receipt viewing process is not indicated from the input unit 18 (No in step S40), the CPU 11 of the portable terminal 8 returns to step S38 and waits for merchandise or an icon correlated with merchandise to be selected.

In addition, with reference to a flowchart of FIG. 22, description will also be made of a case where the portable terminal 8 does not access the electronic receipt management server 9 as described in step S23 of FIG. 11, but the portable terminal 8 receives electronic receipt information and additional information from the electronic receipt management server 9.

The CPU 11 (the electronic receipt reception section 82) of the portable terminal 8 receives electronic receipt information and additional information from the electronic receipt management server 9 (step S61).

Next, if the electronic receipt viewing program P12 is activated (Yes in step 362), the CPU 11 (the electronic receipt display section 83) of the portable terminal 8 displays the received electronic receipt information and additional information in association with a company code (step S63). If a status indicating issuance of a paper receipt is stored in association with electronic receipt information, the text information 80 such as “issuance of a receipt has been completed” indicating that the paper receipt has been issued is displayed in addition to the electronic receipt information and additional information (step S63).

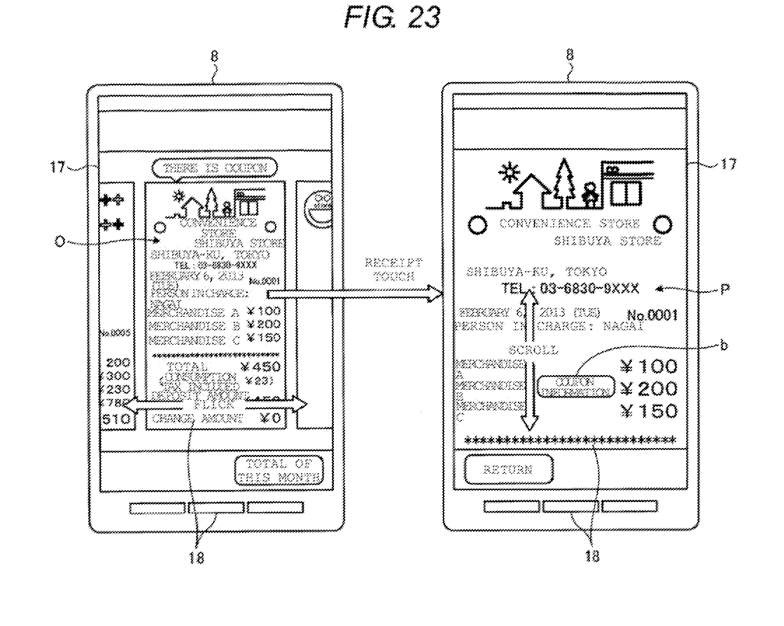

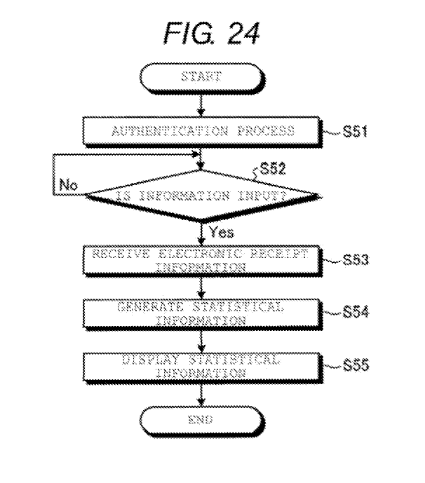

FIG. 23 is a front view illustrating a display transition example on the display unit 17 of the portable terminal 8. In a display example O illustrated in FIG. 23, electronic receipt information is arranged and displayed on a company code basis in an order of being received from the electronic receipt management server 9. In the display example O illustrated in FIG. 23, a single piece of electronic receipt information may be selected through a flick (horizontal sliding of the finger) and touch operation on the input unit 18 (which is, here, a touch panel mounted on the display unit 17). In addition, in electronic receipt information to which coupon information is added, as shown in the display example O illustrated in FIG. 23, a message such as “there is a coupon” is displayed as additional information.

When a single piece of electronic receipt information is selected, as shown in a display example P illustrated in FIG. 23, the selected electronic receipt information is displayed on the display unit 17 of the portable terminal 8. In the display example P, the same layout as that of a paper receipt is displayed by analyzing the electronic receipt information, and the input unit 18 (a touch panel stacked on the display unit 17) may be scrolled. In addition, an icon b (a button-shaped icon indicating “coupon information” in FIG. 23) indicating various additional information pieces correlated with merchandise may be operated via the input unit 18 (a touch panel stacked on the display unit 17).

Next, with reference to a flowchart illustrated in FIG. 24, description will be made of a flow of a statistical information generation process performed by the CPU 11 of the portable terminal 8 being operated according to the statistical information generation program P13.

The CPU 11 of the portable terminal 8 accesses the electronic receipt management server 9, and performs an authentication process by inputting a membership code and a password (step S51).

After the authentication process is performed, if the CPU 1.1 of the portable terminal 8 determines that information required to generate statistical information is input, such as a time period for generating the statistical information or a type of statistical information (Yes in step S52), the CPU 11 receives electronic receipt information managed in the electronic receipt management region 53a in correspondence with the input membership code and the information required to generate statistical information (step S53).

Next, the CPU 11 of the portable terminal 8 generates statistical information based on the information (for example, a company code or a business type and business category code) required to generate the statistical information from the acquired electronic receipt information (step S54), and displays the generated statistical information on the display unit 17 (step S55).

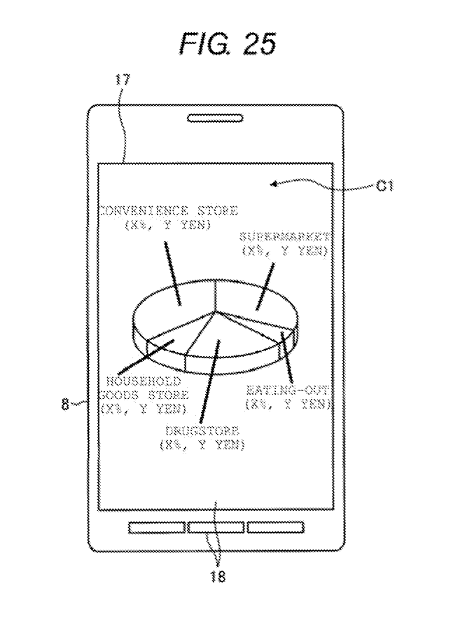

FIG. 25 is a front view illustrating a display example C1 on the display unit 17 of the portable terminal 8. As illustrated in FIG. 25, in the display example C1, a result in which the statistics of a total sales amount in merchandise sales data included in electronic receipt information during a predetermined period are collected on business type and business category bases is displayed by a circle graph. According to the display example C1, a consumption amount on business type and business category bases or information on at a store of which business type and business category shopping is frequently done may be easily understood.

In addition, although the circle graph illustrated in FIG. 25 collects the statistics on business type and business category code bases included in the electronic receipt information, any business type and business category code may be set by a member and may be used as a classification code for arbitrarily classifying companies.

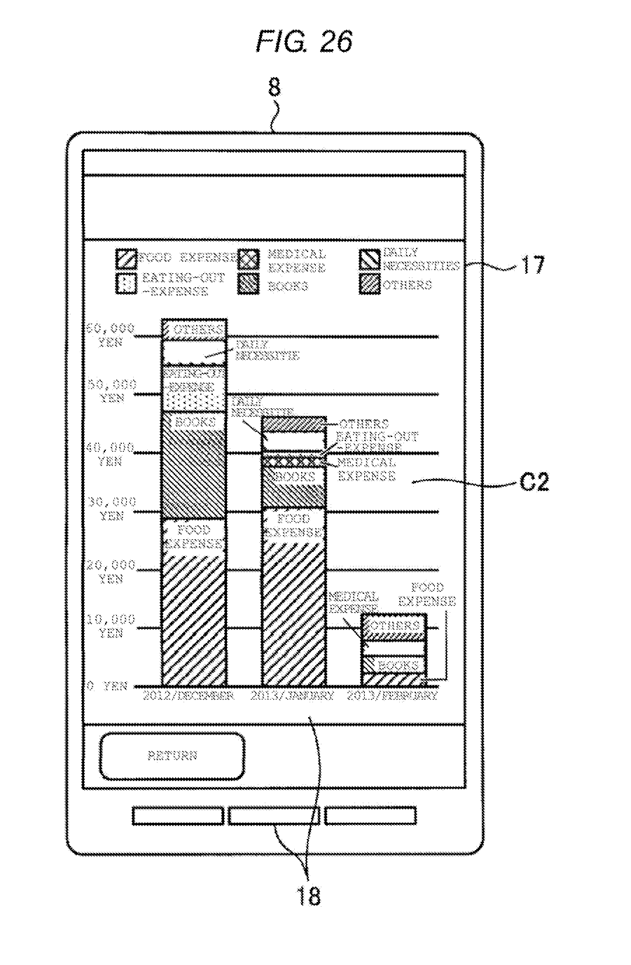

FIG. 26 is a front view illustrating another display example C2 on the display unit 17 of the portable terminal 8. As illustrated in FIG. 26, in the display example C2, a result in which the statistics of a total sales amount in merchandise sales data included in monthly electronic receipt information are collected on a category basis is displayed by a bar graph. According to the display example C2, a consumption amount or ratio on a category basis may be easily understood.

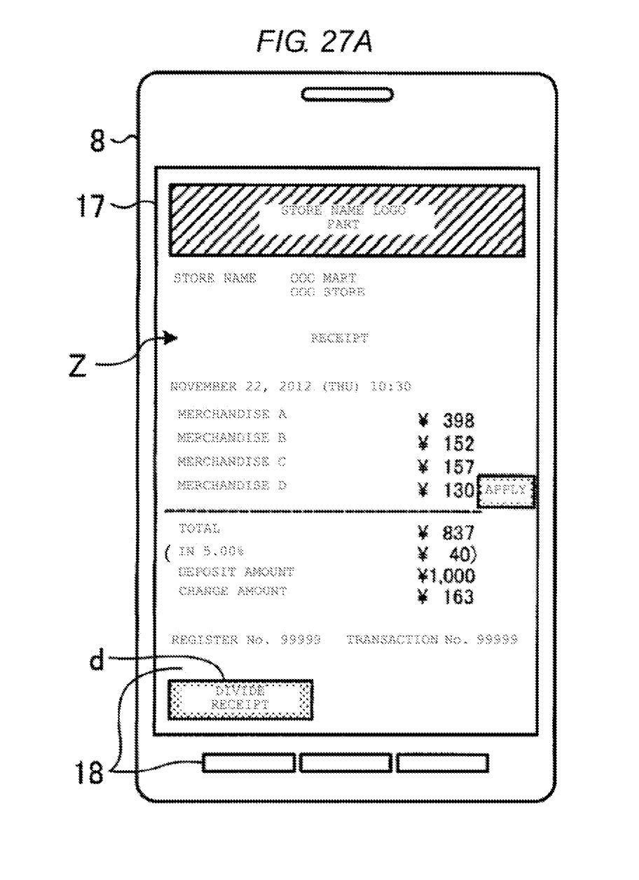

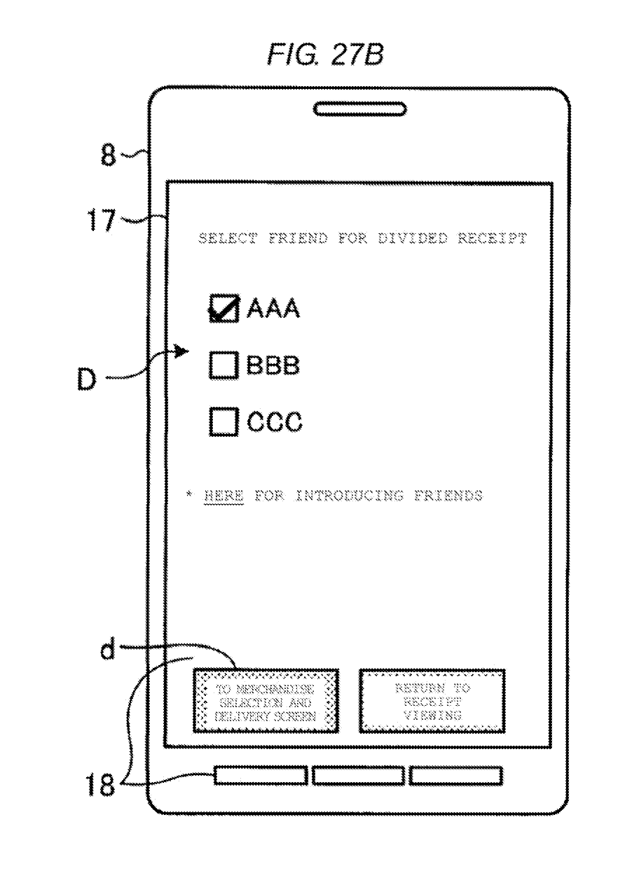

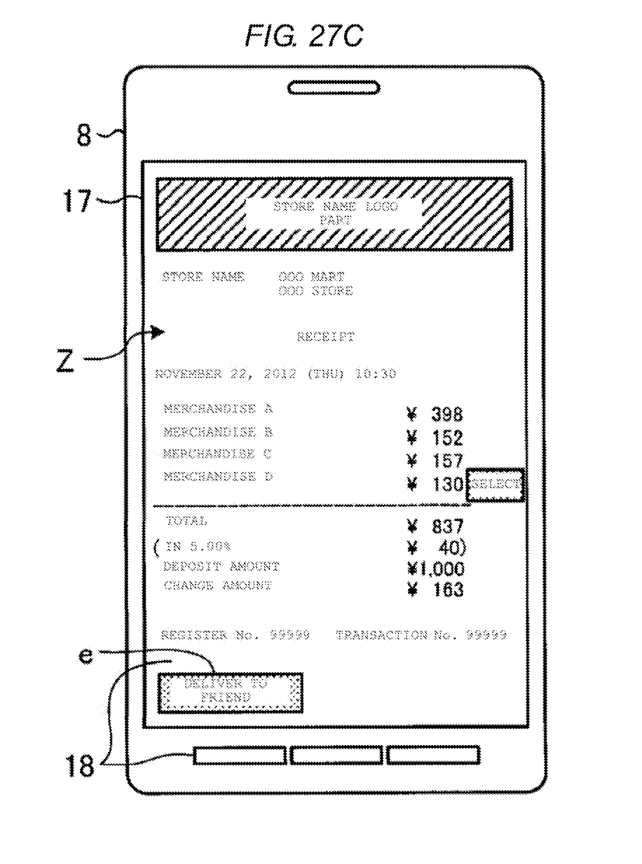

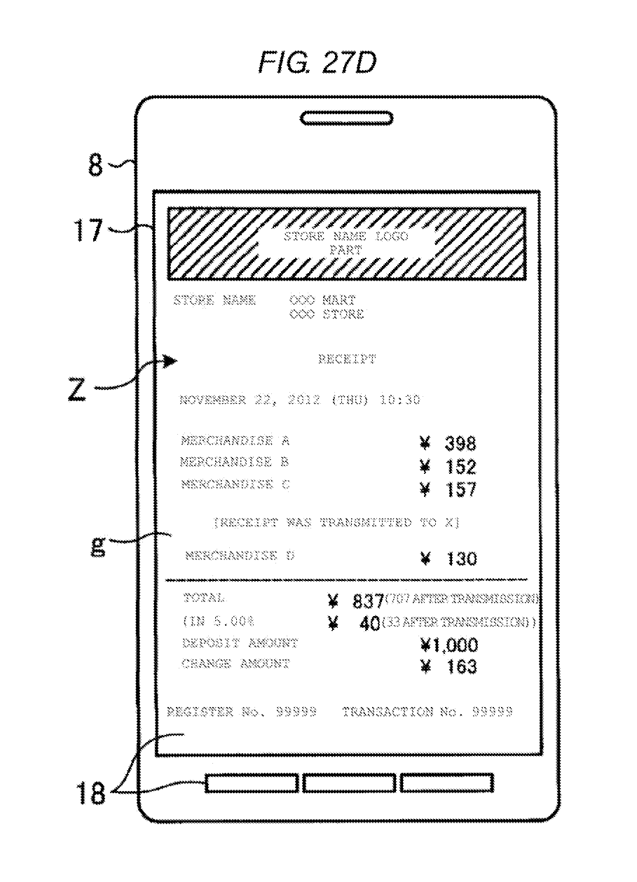

Next, with reference to screen transition diagrams illustrated in FIGS. 27A to 27D, description will be made of a flow of receipt information transfer performed by the CPU 11 of the portable terminal 8 being operated according to the receipt information transfer program P14.

In the related art, when a consumer purchases merchandise on behalf of family or a friend at a food supermarket or the like, the consumer receives payment from the family or the friend by asking a cashier to print and issue a plurality of paper receipts so as to hand over the receipt to the family or the friend, or by presenting content of a receipt which is issued singly to the family or the friend as a certificate of the purchase on checkout.

In relation to this fact, in the present embodiment, electronic receipt information which is purchase data for a proxy purchase is divided and is transferred to family or friends who are registered as members in the electronic receipt system, and thus an accurate shopping certificate may be made.

FIGS. 27A to 270 illustrate a series of displays for a flow of receipt information transfer. As described in FIG. 20, the display example Z illustrated in FIG. 27A displays electronic receipt information of a desired store on a desired date on which the user who owns the portable terminal 8 that accesses the electronic receipt management server 9 does shopping. In addition, in the display example Z illustrated in FIG. 27A, a “receipt division” button d for declaring that electronic receipt information is divided and is transferred is displayed.

As illustrated in FIG. 27A, if the “receipt division” button d is operated, the CPU 11 of the portable terminal 8 displays a display example D (refer to FIG. 27B) for selecting a party to whom electronic receipt information is transferred among family or friends registered as members in the electronic receipt system.

As illustrated in FIG. 27B, among family or friends who are registered as members in the electronic receipt system, if one member of the family or one of the friends is operated so as to be selected, the CPU 11 of the portable terminal 8 returns to the display example Z of the electronic receipt information (FIG. 27C) so as to cause purchased merchandise which is a transfer target to be selected. In addition, in the display example Z illustrated in FIG. 27C, a “delivery to friend” button e for declaring that delivery of electronic receipt information in a division manner is fixed is displayed.

As illustrated in FIG. 27C, if the purchased merchandise which is a transfer target is selected from the electronic receipt information, and the “delivery to friend” button e is operated, divided electronic receipt information is delivered to the transfer party selected in the display example D.

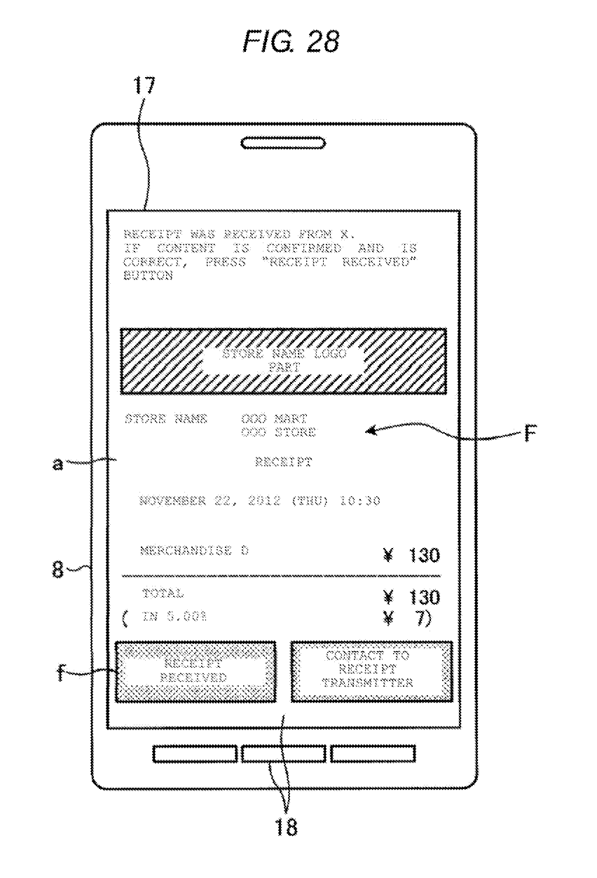

FIG. 28 is a front view illustrating a display example on the display unit 17 of the portable terminal 8 which is a transfer destination. In a display example F illustrated in FIG. 28, the transferred electronic receipt information is displayed. In addition, in the display example F illustrated in FIG. 28, a “receipt reception” button f for declaring that the electronic receipt information has been received is displayed.

If the “receipt reception” button f illustrated in FIG. 28 is operated, information indicating that the electronic receipt information has been received is transmitted to a party who is a transfer source.

In addition, as illustrated in FIG. 27D, if the information indicating that the electronic receipt information has been received is received from the portable terminal 8 which is a transfer destination, the CPU 11 of the portable terminal 8 adds a message g (for example, “a receipt has been transmitted to X”) indicating that the purchased merchandise which is a transfer target is added in the display example Z.

In addition, by applying the system, a shared account may be performed by using electronic receipt information at an eating house, an amusement park, or the like. In addition, in the shared account, division with uniform amount of money, division with a specific weight multiplied, or division with the fraction amount rounded up may be performed.

In addition, members of an electronic receipt may share electronic receipt information. A plurality of membership codes are correlated with each other, and, thus, for example, sales data of merchandise which is purchased by each person may be shared in family, a group, or a department of a company.

As mentioned above, according to the electronic receipt system of the present embodiment, a status indicating that a paper receipt has been issued is generated and is managed, and information indicating issuance of the paper receipt has been completed is displayed on the portable terminal 8 based on the status. For this reason, double accounting processing due to a paper receipt and an electronic receipt may be prevented.

In addition, according to the merchandise sales data processing apparatus of the present embodiment, a status indicating a paper receipt has been issued is transmitted to the electronic receipt management server 9 in association with electronic receipt information, and thus display indicating that the paper receipt has been issued may be performed in the portable terminal 8. Therefore, double accounting processing due to a receipt and an electronic receipt may be prevented.

Further, according to the merchandise sales data processing apparatus of the present embodiment, for example, a barcode displayed on the portable terminal 8 is read, and a transaction number is input. Therefore, when there is a request for issuance of a paper receipt from a consumer later, whether a paper receipt may be issued at that time is determined. In addition, if possible, a paper receipt may be issued. Further, if a paper receipt has been issued, the paper receipt is not issued again. In this way, a salesperson may appropriately handle a request from a consumer.

Further, according to the electronic receipt management server of the present embodiment, a status indicating that a paper receipt has been issued is managed, and information indicating that issuance of the paper receipt has been completed is transmitted to the portable terminal 8. Therefore, the portable terminal 8 may display the information indicating that issuance of the paper receipt has been completed. For this reason, double accounting processing due to a paper receipt and an electronic receipt may be prevented.

In addition, according to the electronic receipt management server 9 of the present embodiment, propriety information based on a managed status may be transmitted in relation to an inquiry about whether a receipt may be issued. For this reason, since a paper receipt may be issued in the POS terminal 2, a salesperson may appropriately handle a request for issuance of a receipt from a consumer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic receipt management server comprising:
a storage unit;
a network interface configured to receive electronic receipt information related to a merchandise sale, membership information of a consumer associated with the merchandise sale, company information of a store associated with the merchandise sale, and a status indicating issuance of a paper receipt in association with the merchandise sale; and
a processor configured to function as:
an electronic receipt management unit that stores the electronic receipt information, the membership information, the company information and the status in association with each other in the storage unit,
an electronic receipt transmission unit that transmits the electronic receipt information, the membership information, and the company information to an information processing apparatus associated with the membership information, and
a paper receipt issuance completion information transmission unit that transmits information indicating that issuance of the paper receipt has been completed according to the status.

2. The server according to claim 1, wherein the processor is further configured to:
receive an inquiry from a terminal regarding whether the status indicating issuance of the paper receipt was received,
determine whether the status was received, and
transmit the determination of whether the status was received to the terminal.

3. The server according to claim 2, wherein the processor transmits an instruction that a new paper receipt should not be issued based on the determination that the status was received.

4. The server according to claim 1, wherein the processor is further configured to:
receive an inquiry from a terminal for all electronic receipt information stored in association with the membership information during a specified period,
retrieve from the storage unit all the electronic receipt information stored in association with the membership information during the specified period, and
transmit the retrieved electronic receipt information to the terminal.

5. The server according to claim 4, wherein the processor is further configured to:
receive authentication information from the terminal, and
prior to transmitting the retrieved electronic receipt information, determine whether the terminal is authorized to receive electronic receipt information.

6. The server according to claim 1, wherein the processor is further configured to:
receive a request to designate one or more merchandise items that were sold in the merchandise sale, and
based on the received request, transmit a second electronic receipt information related to the designated one or more merchandise items to a second information processing apparatus associated with a second membership information.

7. The server according to claim 6, wherein the processor is further configured to:
receive from the information processing apparatus an inquiry of whether the second electronic receipt information has been transmitted, and
transmit information to the information processing apparatus indicating whether the second electronic receipt information was transmitted.

8. A merchandise sales processing apparatus comprising
a storage unit;
a processor configured to function as:
an electronic receipt generation unit that generates electronic receipt information related to a merchandise sale,
a receipt issuance unit that generates a paper receipt related to the merchandise sale, and
a receipt issuance determination unit that determines whether a paper receipt was issued in association with the merchandise sale; and
a network interface configured to transmit, to an electronic receipt management server, the electronic receipt information, membership information of a consumer associated with the merchandise sale, company information of a store associated with the merchandise sale, and status indicating issuance of a paper receipt in association with the merchandise sale.

9. The apparatus according to claim 8, further comprising:
an input unit configured to receive an input specifying whether to generate the paper receipt related to the merchandise sale.

10. The apparatus according to claim 9, further comprising:
a code reading device that reads coded information,
wherein the input received in the input unit is coded information that is displayed on a portable device owned by the consumer and read by the code reading device.

11. The apparatus according to claim 8, wherein the processor is further configured to:
transmit to the electronic receipt management server an inquiry regarding whether the status indicating issuance of the paper receipt was received, and
receive from the electronic receipt management server a determination of whether the status was received,
wherein the receipt issuance unit generates a paper receipt related to the merchandise sale based on the determination.

12. The apparatus according to claim 11, wherein the receipt issuance unit does not generates a paper receipt related to the merchandise sale if the determination indicates that the status was received.

13. The apparatus according to claim 8, wherein the electronic receipt information includes the status indicating issuance of the paper receipt.

14. A method of managing electronic receipts, the method comprising the steps of:
receiving, in a server, information including electronic receipt information related to a merchandise sale, membership information of a consumer associated with the merchandise sale, company information of a store associated with the merchandise sale, and a status indicating issuance of the paper receipt;
storing the electronic receipt information, the membership information, the company information and the status in association with each other in a storage device of the server;
transmitting the electronic receipt information, the membership information, and the company information to an information processing apparatus associated with the membership information; and
transmitting information indicating whether issuance of the receipt has been completed according to the status.

15. The method according to claim 14, further comprising:
receiving an inquiry from a terminal regarding whether the status indicating issuance of the paper receipt was issued in association with the merchandise sale was received,
determining whether the status was received, and
transmitting the determination of whether the status was received to the terminal.

16. The method according to claim 15, further comprising:
transmitting an instruction that a new paper receipt should not be issued based on the determination.

17. The method according to claim 14, further comprising the steps of:
receiving an inquiry from a terminal for all electronic receipt information stored in association with the membership information during a specified period;
retrieving from the storage device all the electronic receipt information stored in association with the membership information during the specified period; and
transmitting the retrieved electronic receipt information to the terminal.

18. The method according to claim 17, further comprising the steps of:
receiving authentication information from the terminal, and
prior to transmitting the retrieved electronic receipt information, determining that the terminal is authorized to receive electronic receipt information.

19. The method according to claim 14, further comprising the steps of:
receiving a request to designate one or more merchandise items that were sold in the merchandise sale, and
based on the received request, transmitting a second electronic receipt information related to the designated one or more merchandise items to a second information processing apparatus associated with a second membership information.

20. The method according to claim 19, further comprising the steps of:
receiving from the information processing apparatus an inquiry of whether the second electronic receipt information has been transmitted, and
transmitting information to the information processing apparatus indicating whether the second electronic receipt information was transmitted.
